(19) United States
(12) Patent Application Publication
(10) Pub. No.: US 2004/0205023 A1
(43) Pub. Date: Oct. 14, 2004

(54) Money transfer convenience card, systems and methods

(75) Inventors: Michael J. Hafer, Highlands Ranch, CO (US); Michael J. Michelsen, Arvada, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/687,575

(22) Filed: Oct. 15, 2003

Related U.S. Application Data
(60) Provisional application No. 60/461,869, filed on Apr. 8, 2003.

(51) Int. Cl. G06F 17/60

(52) U.S. Cl. 705/43

(57) ABSTRACT

Embodiments of the invention provide money transfer convenience cards and methods and systems for using them. Such embodiments can be used in a relationship between a customer, and transaction provider and a service provider. The transaction provider can provide money transfer services for the customer, and the customer can have an account associated with a convenience card. Embodiments of the invention can be used with a variety of service providers. Merely by way of example, in accordance with some embodiments, the service provider can be a merchant or the product can be a tangible good. In accordance with other embodiments, the service provider may be a plurality of service providers, each providing similar and/or different services. In accordance with other embodiments, the service provider can be a telecommunication service provider and/or the product can be a telecommunication service. Thus, in some cases, the award credited to the customer's account by the transaction provider control can comprise sufficient credit to allow the customer to place a telephone call of a certain duration from the transaction's origination location to its destination location.

### CROSS-REFERENCES TO RELATED APPLICATIONS

This application is a nonprovisional and claims the benefit of provisional U.S. Patent App. Ser. No. 60/461,869, entitled “MONEY TRANSFER CONVENIENCE CARD, SYSTEMS AND METHODS FOR ITS USE,” and filed Apr. 8, 2003 by Michelson, the entire disclosure of which is incorporated herein by reference for all purposes.

### BACKGROUND

This invention relates generally to the field of money transfer transactions, and particularly to customer incentives in relation to such transactions. More specifically, the invention relates to methods and systems for incenting customers to engage in money transfer transactions by providing awards, which can be used toward the purchase of other goods and/or services.

In order to compete in the marketplace, businesses continually strive to find new and more effective ways to incent customer purchases of their products and enhance consumer loyalty. For instance, commonly-assigned U.S. patent application Ser. No. 10/079,927, entitled “SYSTEMS AND METHODS FOR OPERATING LOYALTY PROGRAMS,” and filed Feb. 19, 2002 by George et al., the complete disclosure of which is incorporated herein by reference, describes some examples of loyalty systems. Many businesses offer incentives, including frequent flyer miles, “buy-ten-get-one-free” discounts, and the like, in an attempt to attract and retain customers. Often, such incentives relate to discounts on the goods or services being purchased. In many such cases, however, multiple purchases are required before the incentives are of substantial value to customers.

With respect to certain customers, the lack of any immediate realized value from an incentive program can reduce the effectiveness of the incentive program. For instance, in the money-transfer industry, it would be useful if a money-transfer transaction provider could offer in conjunction with a particular transaction an incentive that would be useful to a customer after that single transaction, so that the customer would not have to engage in multiple transactions before realizing any benefit from the incentive. It might be desirable as well for the offered incentive to facilitate the transaction itself and/or enhance the utility of the transaction to the customer.

On the other hand, particular customers might not wish to redeem the offered incentive immediately, preferring instead to allow incentive awards from multiple transactions to accrue before redeeming the awards collectively. For ease of administration, therefore, it would be helpful if the incentive could be offered in conjunction with a stored value account and/or card. For instance, commonly-assigned U.S. patent application Ser. No. 09/971,303, entitled “STORED VALUE CARDS AND METHODS FOR THEIR ISSUANCE,” and filed Oct. 3, 2001 by James et al., the complete disclosure of which is incorporated herein by reference, describes the operation of stored value cards. In this way, the incentive awards could be stored in the stored value account until the customer elected to redeem the awards.

Thus, there is a general need in the art for systems and methods of providing useful incentives to money transfer customers.

### BRIEF SUMMARY OF THE INVENTION

Embodiments of the invention provide money transfer convenience cards and methods and systems for using them. Such embodiments can be used in a relationship between a customer, and transaction provider and a service provider. The transaction provider can provide money transfer services for the customer, and the customer can have an account associated with a convenience card. Embodiments of the invention can be used with a variety of service providers. Merely by way of example, in accordance with some embodiments, the service provider can be a merchant or the product can be a tangible good. In accordance with other embodiments, the service provider may be a plurality of service providers, each providing similar and/or different services. In accordance with other embodiments, the service provider can be a telecommunication service provider and/or the product can be a telecommunication service. Thus, in some cases, the award credited to the customer's account can comprise sufficient credit to allow the customer to place a telephone call of a certain duration from the transaction's origination location to its destination location.

One set of embodiments provides methods for enhancing customer loyalty in money transfer transactions. One such method comprises receiving a request from a customer to process a money transfer transaction. In some cases, the money transfer transaction can have a certain origination location and a certain destination location. The method can further comprise receiving an identifier, which can include sufficient identifying information to allow the customer's account to be identified. Hence, the method can further include identifying the customer's account based on the identifying information included in the identifier and crediting an account with an award based at least in part upon the requested money transfer transaction. The award can be redeemable by the customer for credit towards the purchase of a product from a service provider, and, depending on the embodiment, the account can be maintained by the transaction provider, by the service provider, and/or both.

In some cases, receiving an identifier can comprise receiving an identifier from a convenience card associated with the customer's account. In particular, receiving an identifier can comprise reading an identifier from a convenience card swiped through a point of sale device. In other cases, receiving an identifier can take other forms such as receiving an identifier typed into a keypad, input by voice, and/or the like. In accordance with various embodiments of the invention, identifiers can correspond to a wide variety of values. For instance, in some cases, an identifier will be a telephone number, e-mail address, and/or the like.

In accordance with some embodiments, crediting the customer's account with an award can comprise sending a message to the service provider. Optionally, the message can include sufficient information to indicate the amount of credit to be awarded to the customer's account. Thus, in some cases, the message can specify the amount of credit to be awarded to the customer's account and/or can include sufficient information about the money transfer transaction to allow the service provider to determine the amount of credit to award the customer's account. As such, the message can comprise information about the destination location and/or the origination location of the money transfer transaction.

Another exemplary embodiment provides a method for enhancing customer loyalty in money transfer transactions. The method includes receiving an identifier associated with a money transfer money transfer convenience card, processing a money transfer transaction, and associating the money transfer transaction with the identifier. The convenience card can be associated with an account at a third-party service provider, and the method can further include adding credit to the account at the third-party service provider. The credit can be based, at least in part, on the money transfer transaction.

Yet another exemplary embodiment provides a method for enhancing customer loyalty in money transfer transactions. The method comprises receiving at a point of sale device an identifier from a convenience card. The identifier includes sufficient identifying information to allow the transaction provider to identify the customer's account. The point of sale device can be situated at a particular origination location. The method can further include receiving, at the point of sale device, a request from the customer to process a money transfer transaction. The identifier and the request to process the money transfer transaction can be transmitted via a communication network and received at a transaction provider control. The method can further include identifying a customer's account based on the identifying information, and calculating an amount of prepaid credit sufficient to allow the customer to place a telephone call of a certain duration from the origination location to the destination location. In this way, if desired, the customer can call a receiving party at the destination location, to inform the receiving party of the transaction.

In accordance with various embodiments of the invention, a variety of different awards are contemplated. For instance, in some cases, the award and/or the amount of the award can be based on a determinant. The determinant can be the amount of the money transfer transaction, the originating location of the money transfer transaction, the destination location of the money transfer transaction, the timing of the money transfer transaction, and the like. In addition, the determinant can be an amount of a service fee associated with the money transfer transaction, and/or the type of money transfer transaction requested.

Another set of embodiments provides systems for enhancing customer loyalty in money transfer transactions. Such systems can perform the methods of the invention and may comprise a transaction provider control in communication with a third-party service provider, and a point of sale device in communication with the transaction provider control. Both the transaction provider control and the point of sale device can include a processor, a storage medium and/or an interface. The processors of the transaction provider control and/or the point of sale device can be configured to execute the methods. In certain embodiments, the transaction provider control can comprise another storage medium, which can include a database having a transaction provider account associated with the convenience card. The transaction provider control can, therefore, send instructions executable to update the transaction provider account with information related to the requested money transfer transaction.

In some cases, the transaction provider control can include a database and the database can include information about the customer's account. In other cases, the service provider can comprise a service provider control in communication with the transaction provider control. The service provider control, therefore, can comprise a database and that database can include information about the customer. In other embodiments, both the transaction provider control and the service provider control might include databases, each of which can include information about the customer's account. The customer can have a single account. Both the transaction provider and the service provider and/or the customer can have separate accounts which may or may not be linked, correlated or otherwise associated. Thus, the customer's account can be maintained by the transaction provider, the service provider, or both.

Yet another set of embodiments provides money transfer convenience cards. For instance, an exemplary embodiment provides a money transfer convenience card that can be used to facilitate a money transfer transaction through a transaction provider. The money transfer convenience card can be associated with an account, such that when the money transfer convenience card is used to facilitate a money transfer transaction through a transaction provider, an award is credited to the account associated with the convenience card. The reward can be redeemable towards the purchase of a product from a service provider and/or can be based at least in part on the money transfer transaction. In accordance with certain embodiments, the money transfer convenience card can be used in conjunction with systems and/or methods of the invention.

### BRIEF DESCRIPTION OF THE DRAWINGS

A further understanding of the nature and advantages of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIGS. 1A-1B are schematic diagrams of payment service and/or enrollment systems in accordance with embodiments of the present invention;

FIG. 2A is a logical diagram of a payment service and/or enrollment system similar to the systems illustrated in FIGS. 1;

FIG. 2B is a schematic illustration of a computer system in accordance with various embodiments of the invention;

FIGS. 3A-3D illustrate convenience cards in accordance with embodiments of the invention;

FIG. 4 is a flow diagram illustrating a method of preparing convenience cards in accordance with various embodiments of the invention;

FIG. 5 is a flow diagram illustrating a method of awarding a convenience card in accordance with various embodiments of the invention;

FIGS. 6A-6G illustrate exemplary screen displays that can be used to award a convenience card in accordance with various embodiments of the invention;

FIG. 7 is a flow diagram illustrating a method of recharging a convenience card in accordance with various embodiments of the invention;

FIGS. 8A-8G illustrate exemplary screen displays that can be used to recharge a convenience card in accordance with various embodiments of the invention;

FIG. 9 is a flow diagram illustrating a method of conducting a transaction with a convenience card in accordance with various embodiments of the invention; and

FIGS. 10A-10E illustrate exemplary screen displays that can be used to conduct a transaction with a convenience card in accordance with embodiments of the invention.

### DETAILED DESCRIPTION OF THE INVENTION

Various detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Among other things, the present invention provides convenience cards that can be issued by a transaction provider and used by a customer of that transaction provider, as well as methods and systems for their use. In accordance with some embodiments, convenience cards can be used to store and/or provide loyalty information about a particular customer. (Those skilled in the art will recognize, of course, that while some information may be stored on the card itself, other information can be stored on a computer, and the card can store information, such as an identifier, which can be used to access the information stored on the computer. Thus, while for ease of description, this document may refer to information “stored on a card,” that reference should be interpreted to include information stored on a computer, which may be accessed using an identifier and/or other information stored on the card.) Loyalty information can include a history of transactions made with and/or through the transaction provider, as well as information related to the customers, including without limitation name, address and other biographical information. Loyalty information can further include information related to various promotions, discounts, etc. offered by the transaction provider and/or a third party. In addition, convenience cards can store credits and/or other information related to goods/services provided by a third party provider. As further discussed below, such third party providers are referred to herein as “service providers” and those issuing the convenience cards are referred to as “transaction providers.”

In accordance with some embodiments, convenience cards can also be used as stored value cards, such as phone cards, debit cards and the like, which optionally can be rechargeable. In a particular aspect, convenience cards can be given to customers of a service provider and can be used to facilitate money transfers and other transactions through that provider, as well, in some cases, as through third party providers. In effect, when a customer conducts a transaction, including without limitation a money transfer transaction, using particular provider, the customer can be given one or more convenience cards, by the provider or by a third party.

Convenience cards in accordance with embodiments of the invention can be used to store loyalty information (and/or store an identifier, which can be used to access loyalty information stored on a host, which can be at the transaction service provider) about the customer for the provider issuing the card and/or for third party providers. In some instances, convenience cards can be used as well to obtain other services, such as prepaid telecommunication services (e.g., long distance calling, etc.), and the convenience cards can be used to store value and/or credit in relation to those services, as well as other funds. For instance, a convenience card used to store loyalty information could also be used to store credit for a variety of other products/services, including credit toward prepaid telecommunication services, credit redeemable at a store or chain of stores, and the like. As discussed below, some embodiments of convenience cards can be used to maintain a cash balance, which can be withdrawn through ATMs, accessed via a credit card network, and the like.

In accordance with some embodiments, a convenience card may be associated with a personal identification number (“PIN”) and/or similar identifier. The PIN can be selected by the customer and/or can be pre-assigned by the issuing provider. In certain embodiments, the PIN (and/or other information capable of identifying a particular convenience card) can be associated with a customer (e.g., with a customer number established by the provider), so that all (and/or some subset) of the transactions conducted by that customer can be rewarded with credit (e.g., prepaid calling minutes, frequent flier miles, frequent buyer points, etc.), which can, if desired, be directly added by the provider (and/or a third party) to the convenience card and/or account associated with that customer.

Convenience cards in accordance with other embodiments can be ‘recharged’ with additional credit. For instance, a customer may add credit directly to the convenience card, though any of several methods, including without limitation visiting the issuing provider and paying for credit to be added, calling a telephone number associated with the provider to add credit, visiting the provider's web site and adding credit using an online form, and/or the like. Additionally, the customer could contact the provider of the services (e.g., the long distance telephone company, etc.) over the Internet, by phone, etc. to add credit. Further, credit could be added to a convenience card as a result of the customer receiving rewards and/or promotions from the provider. Moreover, in embodiments in which the convenience card is associated with particular customer (e.g., by associating the card's PIN number with a customer number), credit can be added to the card by the provider by reference to the customer's number and/or other identifying information, such that the customer need not present the convenience card to recharge the credit on the card.

Those skilled in the art will recognize, therefore, that convenience cards in accordance with embodiments of the invention can help facilitate future transactions involving the customer, as discussed in detail below. In accordance with other embodiments, the convenience card can incorporate loyalty incentives to encourage repeat business by the customer. For instance, the convenience card can be used to track transactions placed by the customer and reward repeat transaction. Merely by way of example, a customer who places four transactions might be eligible to receive the fifth transaction at a discount.

In addition, certain embodiments include information that allows the convenience cards to be used to purchase products and/or services, either from the transaction provider or from another service provider. For instance, in some cases, convenience cards can also be used as calling cards: On the back of the physical convenience card, there is an identifier, as well, perhaps as a 1-800 number that enables the consumer to use the card exactly as any other phone card.

Merely by way of example, in accordance with an exemplary embodiment, a convenience card can also be used to place long distance telephone calls. In the transaction provider's system, each card number (which can be an identifying number to the transaction provider's system) is assigned a corresponding PIN prior to the issuance of the card. This PIN can be thought of as the identifier that is used by a telecommunication service provider to identify and guarantee uniqueness in the service provider's system, which can be separate system from the transaction provider's system. The PINs can be either generated by the transaction provider and supplied to the telecommunication service provider or created by the telecommunication service provider and provided to the transaction provider.

In accordance with such embodiments, when a consumer is registered in the transaction provider's system as a new “Convenience Card” member upon engaging in a transaction and/or enrolling in the transaction provider's “Convenience Card” program, the consumer may be given a physical convenience card. Hence, the PIN number that is on the back of the physical card in the consumer's possession has been matched to an identifier in the transaction provider's system (e.g., the convenience card number) that is provided to the transaction provider when the convenience card is issued to the consumer.

Hence, when the convenience card is issued, it is possible to add automatic phone time (i.e., credit for telecommunication services) onto the consumer's card. This can be done, as discussed in detail below, by subsequent communications that take place between the transaction provider's system and that of the telecommunication service provider that supports the PIN on the consumer's card. The communication may take place in any message structure, using any suitable protocol. Generally, a minimal data set sent to the service provider by the transaction provider might include the recharge credit amount and the convenience card number. Additional data fields passed may include PIN, merchant ID, and the like. In accordance with some embodiments, cards may be activated without adding any credit to the card. In other embodiments, a separate process may be implemented to add more credit onto the customer's convenience card account. If a card becomes lost, the customer can call a designated number (or be directed to a designated number by a representative of the transaction provider and/or service provider) to report the lost card, at which point any remaining credit, along with all loyalty information, transaction information, etc., can be transferred to a new card, which can be mailed to the customer and/or picked up from a representative location.

In accordance with other embodiments, the convenience card can be used to purchase credit for prepaid and other services, even if those services are not associated with the convenience card itself, by using transactions, such as those discussed below, to make payments to providers of such services.

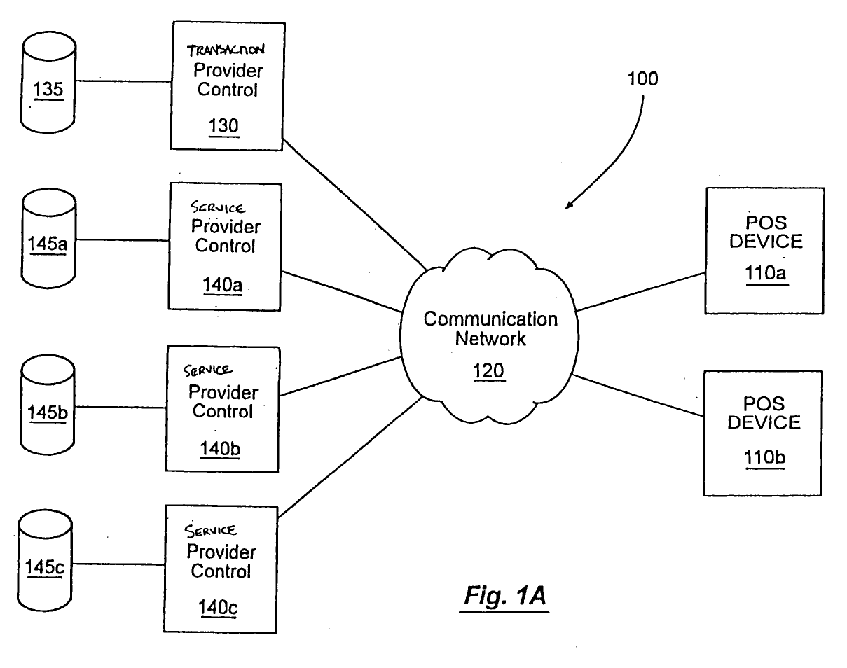

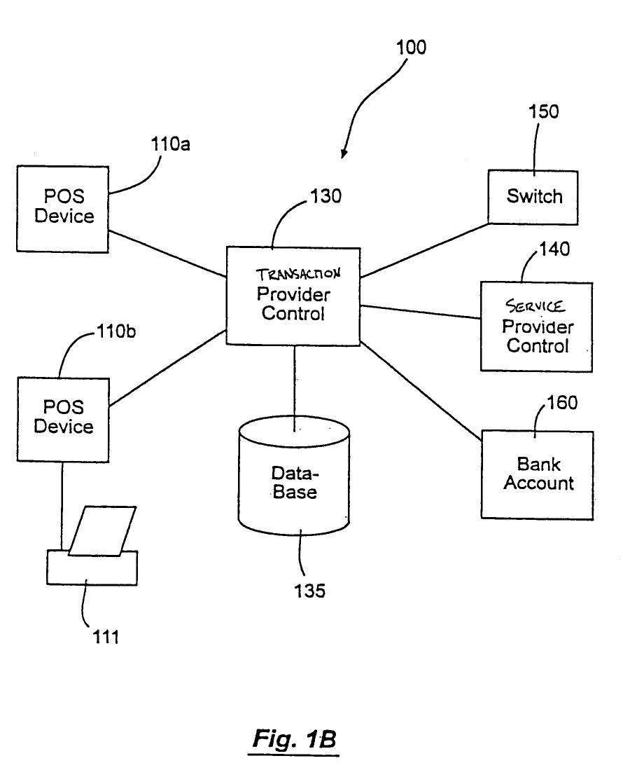

Referring to FIG. 1A, an enrollment and payment system 100 is illustrated that may be used to provide convenience card services, facilitate payments made to purchase goods or services, and/or provide enrollment services in accordance with an embodiment of the present invention. System 100, which in some ways can be similar to systems described in U.S. patent application Ser. No. 10/112,258 entitled ELECTRONIC IDENTIFIER PAYMENT SYSTEMS AND METHODS,” and filed Mar. 29, 2002, the entire disclosure of which is incorporated herein by reference for all purposes, includes a point-of-sale (“POS”) device 110 in communication with a transaction provider control 130 via a communication network 120. In addition, transaction provider control 130 is communicably coupled to one or more service provider controls 140 via communication network 120. Transaction provider control 130 is associated with a transaction provider database 135 and service provider controls 140 are associated with service provider databases 145. As will be evident from the proceeding discussion, system 100 can include any number of POS devices 110 and service provider controls 140 in accordance with the various embodiments of the present invention.

POS device 110 can be any device disposed at the point-of-sale. Thus, POS device 110 can one such as is described in the following commonly-assigned applications the entire disclosures of which are incorporated herein by reference for all purposes: U.S. Prov. Pat. Appl. No. 60/147,889, entitled “INTEGRATED POINT OF SALE DEVICE,” filed Aug. 9, 1999 by Randy J. Templeton et al.; U.S. patent application Ser. No. 09/634,901, entitled “POINT OF SALE PAYMENT SYSTEM,” filed Aug. 9, 2000 by Randy J. Templeton et al.; U.S. patent application Ser. No. 10/116,689, entitled “SYSTEMS AND METHODS FOR PERFORMING TRANSACTIONS AT A POINT-OF-SALE,” filed Apr. 3, 2002 by Eamey Stoutenburg et al.; U.S. patent application Ser. No. 10/116,733, entitled “SYSTEMS AND METHODS FOR DEPLOYING A POINT-OF-SALE SYSTEM,” filed Apr. 3, 2002 by Earney Stoutenburg et al.; U.S. patent application Ser. No. 10/116,686, entitled “SYSTEMS AND METHODS FOR UTILIZING A POINT-OF-SALE SYSTEM,” filed Apr. 3, 2002 by Earney Stoutenburg et al.; and U.S. patent application Ser. No. 10/116,735, entitled “SYSTEMS AND METHODS FOR CONFIGURING A POINT-OF-SALE SYSTEM,” filed Apr. 3, 2002 by Earney Stoutenburg. Further, based on the description provided herein, one of ordinary skill in the art will recognize that other devices are capable of operating as POS device 110. For example, POS device 110 can be a personal computer (“PC”), a personal digital assistant (“PDA”), or the like.

As used herein, a service provider is any entity that offers goods and/or services for sale to consumers. Merely by way of example, one particular type of service provider is a telecommunication service provider, which can provide telecommunication services, which can be prepaid, including telephone, facsimile, Internet and other such services. Service providers often maintain service provider controls 140 to maintain accounts and other information related to the consumers that they serve. Such service provider controls 140 can be any type of computer capable of communicating with other types of communication devices or computers. For example, service provider control 140 can be a mainframe computer, such as those available from Tandem, a server computer, or the like. In some cases, service providers can provide services using a convenience card as a means of payment. For instance, a convenience card can store prepaid credit for goods and/or services that may be purchased from a service provider. Merely by way of example, a convenience card may store credits in the form of prepaid telephone “minutes” that can be used to make long distance or other toll telephone calls.

A transaction provider can be any entity that issues a convenience card and/or provides services associated with and/or facilitated by a convenience card, as described herein. In many instances, a transaction provider also will provide financial services, including, merely by way of example, money transfer services, bill payment services, and the like. Thus, in some cases, a transaction provider is an entity that provides both POS device 110 and transaction provider control 130. In other cases, a transaction provider is an entity that provides transaction provider control 130, and accepts inputs from POS devices 110 operated by third parties. In yet other cases, a transaction provider is an entity that provides POS device 110 that interacts directly with service provider controls 140 without utilizing transaction provider control 130. In still other cases, a transaction provider can be a payment acceptance provider, such as the “payment provider” identified in U.S. patent application Ser. No. 10/112,258, already incorporated herein by reference.

In some embodiments of the present invention, service providers 140 issue unique identifiers which are associated with a good or service that are electronically transmitted to transaction provider 130, where they can be stored in database 135. These identifiers may be associated with specific consumers. For example, when requesting a good or service, the service provider may create an account, and an identifier can then be associated with the account and issued to the consumer. Alternatively, the identifiers may be associated with a good or service, but not to any given consumer. For example, the identifiers may be associated with some type of stored value, such as phone time, dollars and the like. This value may be redeemed simply by presenting the identifier to the service provider. In one aspect, an identifier can be considered personal identification numbers (“PIN”).

Communication network 120 can be any network capable of transmitting and receiving information in relation to POS device 110, service provider controls 140, and transaction provider controls 130. For example, communication network 120 can comprise a TCP/IP compliant virtual private network (“VPN”), the Internet, a local area network (“LAN”), a wide area network (“WAN”), a telephone network, a cellular telephone network, an optical network, a wireless network, or any other similar communication network.

In some embodiments, communication network 120 is a combination of a variety of network types. For example, in one embodiment, communication network comprises the Internet for communicating between POS device 110 and transaction provider control 130, and a dial-up network for communicating between transaction provider control 130 and service provider controls 140. In light of this document, one of ordinary skill in the art will recognize a number of other network types and/or combinations thereof that are capable of facilitating communications between the various components of system 100.

Referring to FIG. 11B, a logical diagram of system 100 of FIG. 1A is illustrated. Central to system 100 is transaction provider control 130. In particular embodiments, transaction provider control 130 is comprised of a host computer capable of accessing one or more databases 135. Further, transaction provider control 130 facilitates data transfer between one or more service providers 140 and one or more POS devices 110, or other computer terminals. Transaction provider control 130 can be any type of computer capable of communicating with other types of communication devices or computers. For example, transaction provider 130 can be a mainframe computer, such as those available from Tandem, a server computer, or the like.

POS devices 110 communicate with transaction provider control 130 in order to process activate, configure and/or recharge convenience cards, as well as to process transactions, which may be facilitated by the use of convenience cards. For example, when ready to make a payment, a consumer may present a convenience card to a representative of the transaction provider, which can be read by POS device 110. The POS device 110 can obtain certain loyalty information from the magnetic stripe on the convenience card, and it can contact transaction provider control 130 to obtain additional information about the customer and/or any relevant transactions. In this way, the convenience card can greatly facilitate a transaction (such as, for example, a money transfer transaction), by eliminating to a great extent the data entry required to complete the transaction.

For instance, upon reading the convenience card, the POS device 110 can display for the representative a list of recent transactions, which can either be stored on the convenience card or downloaded from transaction provider control 130 based on customer identifying information stored on the convenience card. The customer, then, can be given the option of repeating any of those transaction, optionally with modified terms (e.g., a payment or money transfer to the same recipient but for a different amount). Alternatively, the customer might want to initiate a new transaction, such that the stored transaction information would not be helpful; however, the customer's biographical information, as well as any other desired information, can be entered automatically into the proper fields on the transaction form on POS device 110. In this way, convenience cards can make a transaction much more efficient and convenient for both the customer and the representative, as well as decreasing the odds of incorrect data entry. In some cases, therefore, the transaction provider might offer slightly lower transaction fees to reflect the lower administrative costs of transactions utilizing convenience cards. Further, as discussed below, the transaction provider can offer a variety of other incentives to users of convenience cards, including discounts, special promotions, and credit toward goods/services offered by a service provider. Such credits can, for example, be added to a convenience card automatically by transaction provider control 130 (e.g., via POS device 110) when the customer uses the card.

In addition, POS devices 110 can be used to add purchased credit to a convenience card. For instance, the consumer may wish to purchase long distance “minutes” from a certain phone company. In such cases, the consumer makes a request to purchase the phone time, perhaps from a representative of the transaction provider. The transaction provider can “swipe” the convenience card through the POS device 110, so that information stored on the card is entered into POS device 110, and the representative can further enter information indicating that the customer is interested in acquiring phone time from the service provider. POS device 110 may then display payment options for that provider as received from the transaction provider control 130. For example, payment in increments of $5, $10, $25 and $50 may be accepted. Upon receipt of payment, the transaction provider notifies the service provider of the payment, and the stored value associated with the convenience card is updated. In certain embodiments, the stored value is available for immediate use. Conveniently, a printer 110 may print a receipt with the identifier.

At the time of payment, other funds may also be collected. For example, the transaction provider may charge and collect a fee for its services. As another example, applicable taxes may be calculated and collected. These taxes may be calculated by transaction provider control 130 in combination with database 135 and may include tax tables for various locations throughout the country. When tendering payment, the consumer may provide information on his residential address, such as a zip code. This information is transmitted to transaction provider control 130, which performs a look-up in database 135 to determine the appropriate tax rate. Transaction provider control 130 then computes the tax and sends the tax information to computer 308. The payment amount, taxes, and any service fees may then be displayed to the consumer on a display screen. Alternatively, the taxes may be computed directly by POS device 110 and based on the location of POS device 110, or in part by POS device 110 and in part by transaction provider control 130.

Transaction provider control 130 may also be used to electronically transfer the payment along with any collected taxes to the service provider. This may conveniently occur by an ACH transfer of funds into a bank account 160 of the service provider. This may occur upon receipt of the payment information by transaction provider control 130 or by batch mode at specified times. A record of the deposit may separately be transmitted to service provider control 140. Transaction provider control 130 can be configured to communicate with a separate ACH system that debits the account of the consumer and credits the account of the service provider as is known in the art.

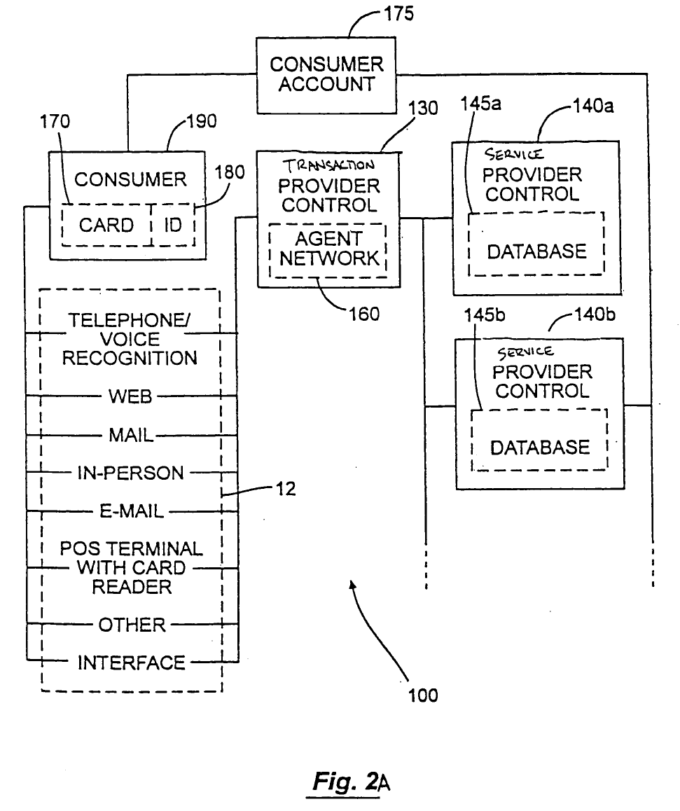

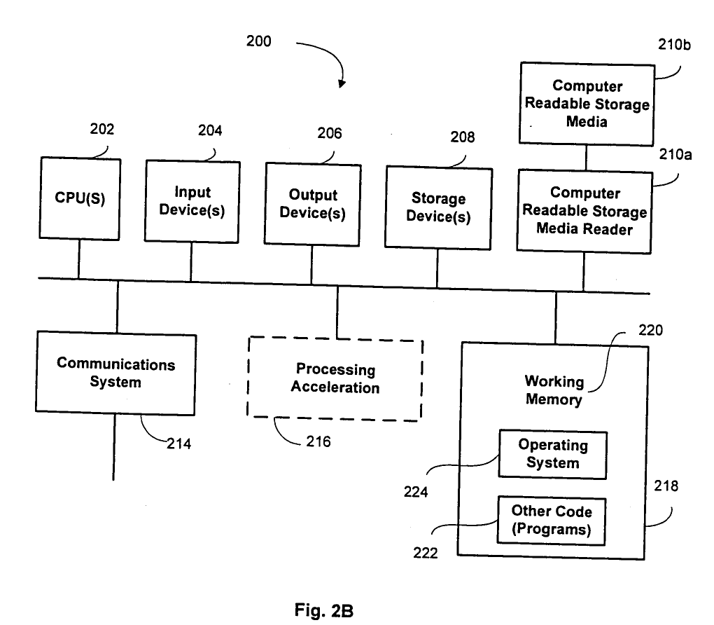

Referring to FIG. 2A, another embodiment of system 100 is illustrated including discussion of additional elements. As shown, system 100 includes transaction provider control 130 for facilitating transactions for a consumer 190, as well as activating, configuring and/or recharging a convenience card for the customer 190.

Each consumer 190 has an ID 180, which can comprise any suitable identifier, and which can be associated with a number embossed on the consumer's convenience card. Conventional identifiers such as name, social security number, etc. are acceptable. Consumer 190 interfaces with transaction provider control 130 through an interface 12. Interface 12 can comprise any suitable form or device for communications, including telephone (which can incorporate voice recognition (“VR”)), worldwide web (Internet), mail, in-person, a point-of-sale (“POS”) terminal with a card reader, e-mail or any other suitable interface. As with the other embodiments, interface 12 can be a POS device 110. Further, in some embodiments, such a POS device 110 can be installed at a retail outlet unrelated to any of various service provider controls 140 and/or transaction provider controls 130 accessible via system 100.

In this particular embodiment, transaction provider control 130 includes a representative network 160, where representatives in the network provide POS devices 110 at locations accessible to consumer 190. Transaction provider control 130 maintains service provider accounts 175, which can correspond to the various service providers represented by service provider controls 140. In some embodiments, each service provider control 140 can have associated therewith a database 145 containing pertinent information regarding the consumers 190 and their respective accounts. (The designation of accounts, sub-accounts, master accounts, etc. can vary from service provider to service provider. Thus, as used herein the terms account, sub-account and similar terms can designate either the entire account base of a particular service provider control 140, or the individual account of consumer(s) 190.) In other embodiments, the service provider control might track only a list of identifiers (e.g., PINs), along with a credit balance related to each PIN. In such embodiments, correlation between a particular identifier and a customer is maintained by the transaction provider and/or stored by the convenience card.

In one embodiment, representative network 160 comprises a host computer (not shown) that may be accessed by a variety of remote computers or other devices, such as those described in connection with interface 12. For example, the host computer may comprise a mainframe computer, a server computer, or the like. A database may also be associated with the host computer. In this way, information from consumer databases 145 may be transmitted to the host computer and stored in the database. When a consumer 190 contacts representative network 160, it may be through the host computer. Hence, with this configuration, a consumer may proceed with a transaction using interface 12 which contacts the host computer of representative network 160 to receive consumer information, such as the unique identifier, and to transmit payment information back to the host computer. The host computer may also serve to coordinate a wire transfer of the payment to a bank account of the service provider as well as to transmit payment information to service provider control of the service provider. Electronic funds transfers may conveniently be made through an automated clearing house (ACH) system that is contacted by the host computer. ACH transfers are well known within the art and will not be described further.

FIG. 2B is a schematic illustration of one embodiment of a computer system 200 that can perform the methods of the invention and/or the functions of a transaction provider control, POS device and/or service provider control, as described herein. This figure broadly illustrates how individual system elements may be implemented in a separated or more integrated manner. The computer system 200 is shown comprised of hardware elements that are electrically coupled via bus 226, including a processor 202, an input device 204, an output device 206, a storage device 208, a computer-readable storage media reader 210a, a communications system 214, a processing acceleration unit 216 such as a DSP or special-purpose processor, and a memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged with the Internet, DTMF processor, cable processor, and/or between and among the transaction provider controls, service provider controls and POS devices described above.

The computer system 200 also can comprise software elements, shown as being currently located within working memory 220, including an operating system 224 and other code 222, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

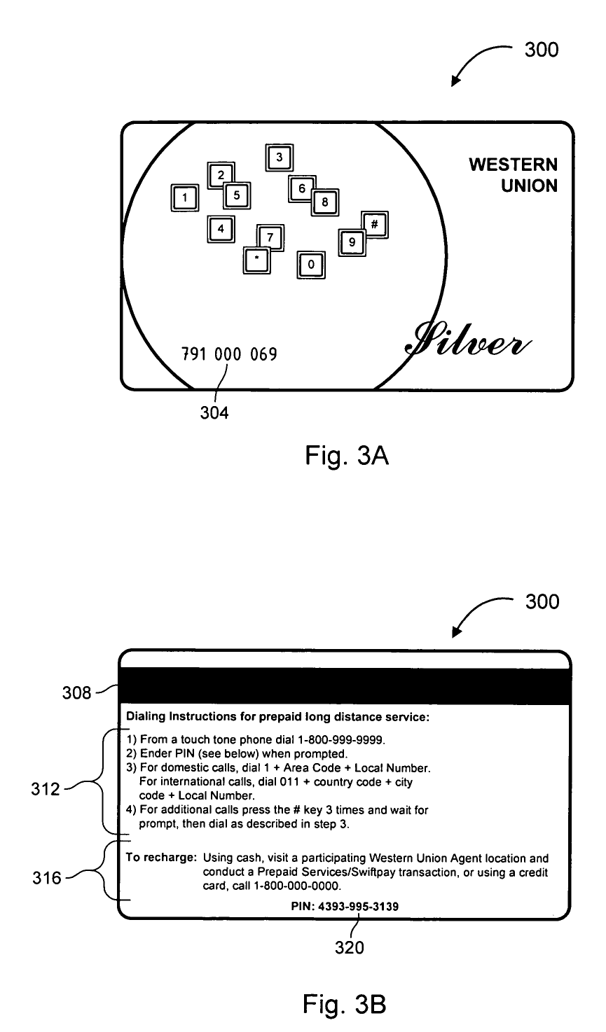

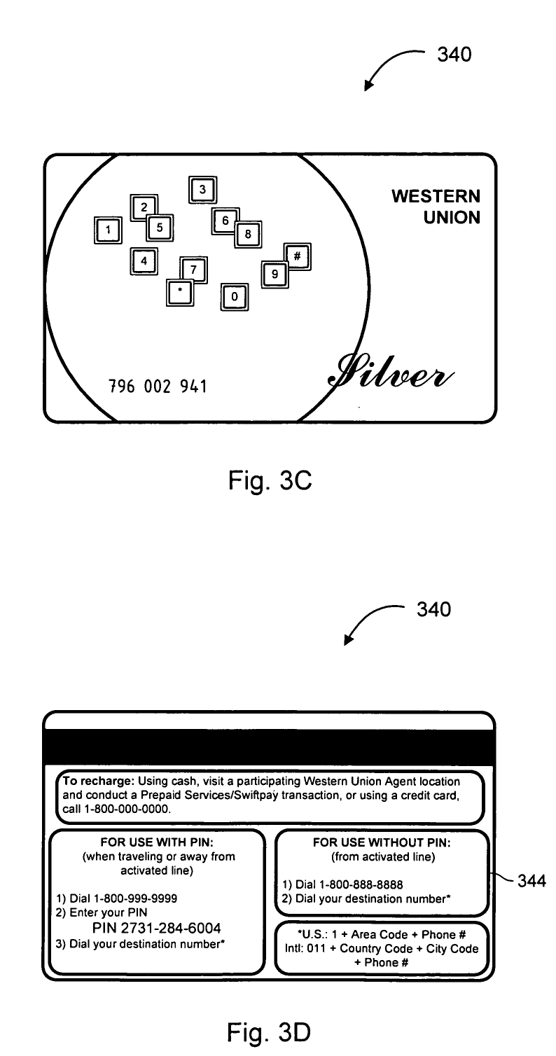

FIGS. 3A-3D illustrate exemplary convenience cards in accordance with certain embodiments of the invention. For instance, a convenience card 300 as illustrated on FIGS. 3A and 3B can comprise a card number, which can be embossed and which may be associated with a customer number maintained by a transaction service provider and/or with other information identifying a particular customer, such as a telephone number, social security number, and the like. The convenience card 300 can further include an information storage device, such as a magnetic stripe 308, bar code and/or the like, which are familiar to those skilled in the art. The storage device (e.g., magnetic stripe 308) can store a variety of information, including without limitation biographical and/or demographic information about the customer, information about recent transactions, information about discounts and/or promotions for which the customer currently is eligible, and/or information about credit balances with one or more service providers. In lieu of some or all of this information, the magnetic stripe 308 can store identifying information about the customer and/or card number, and the identifying information can be used, perhaps by a POS device as described above, to download pertinent information (which can include any of the aforementioned information), from a transaction provider. Optionally, the information stored on the magnetic stripe 308 can be encoded for security.

In accordance with some embodiments, the convenience card 300 can further include instructions 312 for using the card 300 to obtain services from a service provider. In certain aspects, the services referenced by instructions 312 can be services for which magnetic stripe 308 stores accumulated credit. In addition, the card 300 can include instructions 316 for refreshing the credit balance on the card 300. Card 300 also can include a PIN 320 or other code, which can be associated with an identifier (e.g., PIN) maintained by the service provider, to allow the service provider and/or transaction provider to debit/credit the credit balance associated with the convenience card depending on actions taken by the customer (e.g., use of the services, payment for additional credit, rewards from the transaction provider, etc.). In some cases, the PIN 320 can be the PIN issued by the service provider. In other cases, the identifier 320 can be concealed, for instance, by a scratch-off coating on card 300.

In accordance with other embodiments, including for example, the embodiments illustrated by the exemplary card 340 of FIGS. 3C and 3D, services optionally can be used via the convenience card without a service provider PIN. In such cases, additional instructions can be given on the card 340 for activation without a PIN. Thus, under certain circumstances, the customer can use the services (and have credit debited from the card 340) without having to enter an identifier. For example, in the case of long distance phone time, the customer can have a telephone number associated with the identifier, such that calls placed to/from that number can be paid for by credit from card 340 without the use of a PIN.

In some cases, a customer can be awarded a convenience card when making a transaction with transaction provider, and, optionally, the card can be preconfigured with a cash balance and/or a credit balance, which can be used toward certain goods and/or services, as a way of rewarding the customer for placing the transaction, as well as a way of encouraging loyalty in the future. In other cases, the customer may be presented with a convenience card upon request, for instance, by enrolling in (providing information to) the transaction provider's convenience card system.

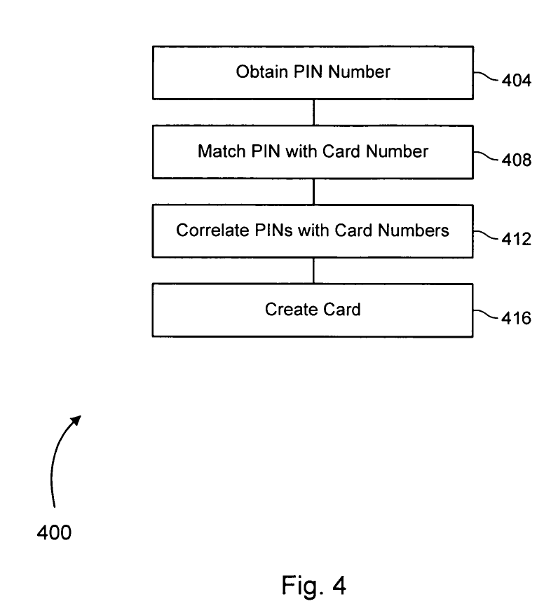

Turning now to FIG. 4, a method 400 is illustrated for preparing convenience cards in accordance with embodiments of the invention. At block 404, the transaction provider obtains a block of identifiers (e.g., PINs) from a service provider. The PINs can be transferred from the service provider to the transaction provider as a data file using any connection known to those skilled in the art, including, merely by way of example, via a network connection between a service provider control (e.g., 140a) and the payment provider control 130, as discussed above. In some embodiments, the data file can explicitly and/or implicitly identify each PIN and, optionally, provide an indication of an initial amount of credit associated with each PIN. Alternatively, a service provider might simply authorize the transaction provider to use a reserved set of PINs (e.g., a range of PIN numbers) through an informal communication, without any formal transfer of specific PINs.

In some cases, the transaction provider might pay a fee associated with each PIN, and each PIN optionally might have a credit balance when obtained by the transaction provider. In other cases, the transaction provider might not pay any fee to the service provider for the PINs, and/or the PINs might not be associated with any credit upon receipt by the transaction provider. In either case, the transaction provider and/or the customer receiving a convenience card generally can add cash and/or credit to the card (perhaps to be used in conjunction with the PIN) at a later time, as discussed in more detail below. Generally, each of the PINs received by the transaction provider can be pre-associated with an account maintained by the service provider before transfer to the transaction provider, and/or each of the PINs can be associated with an account maintained by the service provider upon the first use and/or first addition of credit to the PIN.

At block 408, each PIN can be associated with a given card number. In some cases, this association can comprise a database link between a given PIN and the convenience card with which it is associated, perhaps in a database residing at transaction provider control 130. Optionally, at block 412, the transaction provider can communicate with the service provider regarding the correlation between each PIN received from the service provider and the associated card number. If so, the service provider can track the credit in a particular account by reference to the convenience card number as well as by reference to the PIN number, allowing additional efficiency for the service provider, the transaction provider, and/or the customer. Merely by way of example, if the customer and/or the transaction provider wishes to add credit to a particular PIN, a credit addition request can be sent to the service provider referencing either the card number and/or the PIN number so that, if desired, neither the customer nor the transaction provider need specifically reference a particular PIN number when adding credit to be associated with a particular card number.

At block 416, a convenience card can be created. In certain embodiments, the convenience card, as discussed above with reference to FIGS. 3A to 3D, can include an embossed card number, a magnetic stripe, an indication of the PIN number associated with the card, etc. Those skilled in the art will recognize that there are several available methods for manufacturing magnetic stripe cards and any of these methods can be used in accordance with various embodiments of the invention. In some cases, cards can be pre-manufactured, perhaps at a central location, and sent in bulk to representatives for distribution to customers. In other cases, cards can be created and/or modified dynamically, perhaps at a representative location, allowing for further customization of a particular convenience card to include, merely by way of example, a customer name and/or other information customized for a particular customer. In certain embodiments, as mentioned above, the PIN indicator can be concealed at the time of purchase, using a scratch-off coating or some similar device, to prevent use of the PIN until after purchase. In other embodiments, the PIN can require activation (which can, if desired, take place via a POS device and/or the like) prior to use.

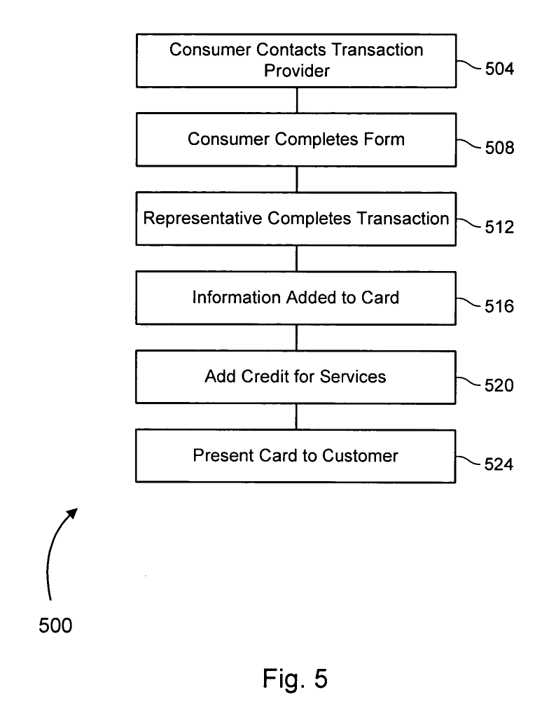

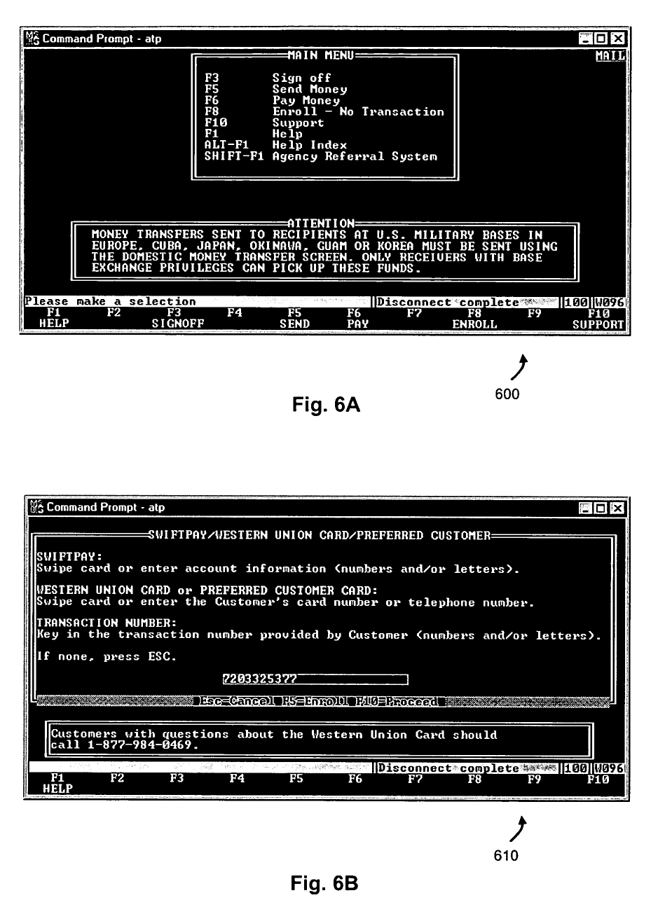

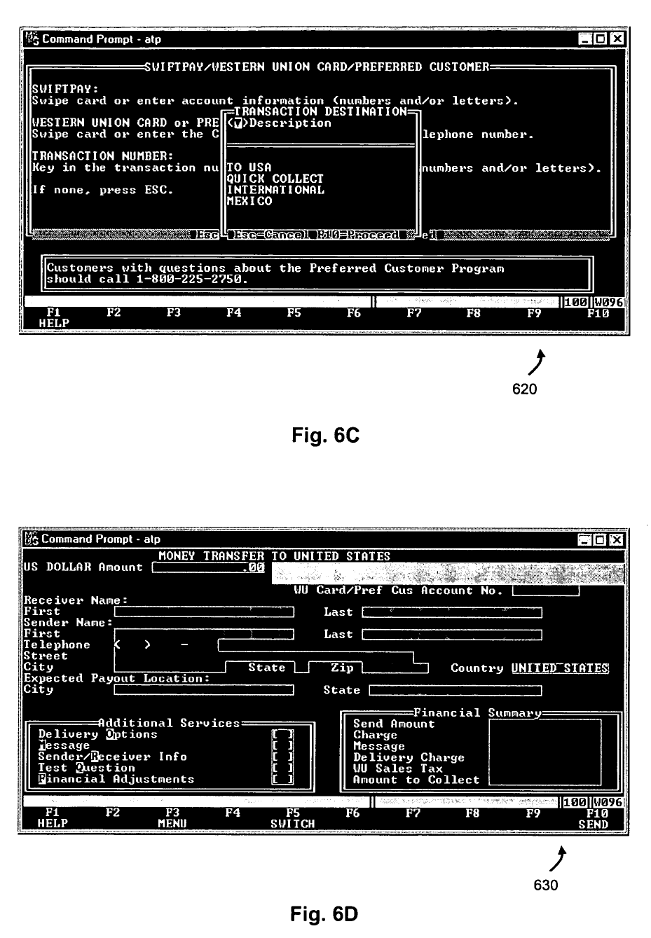

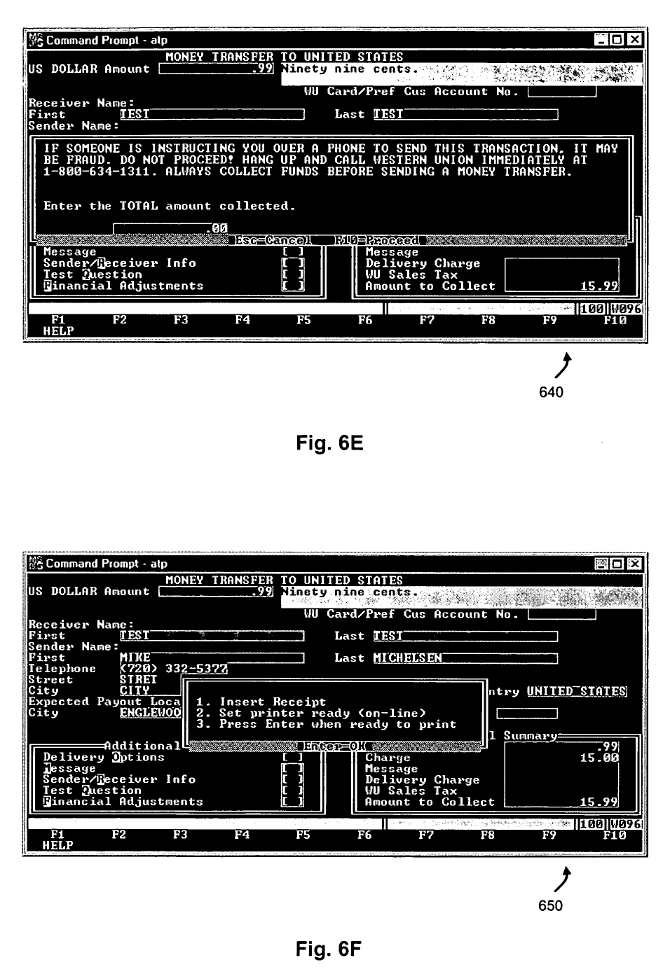

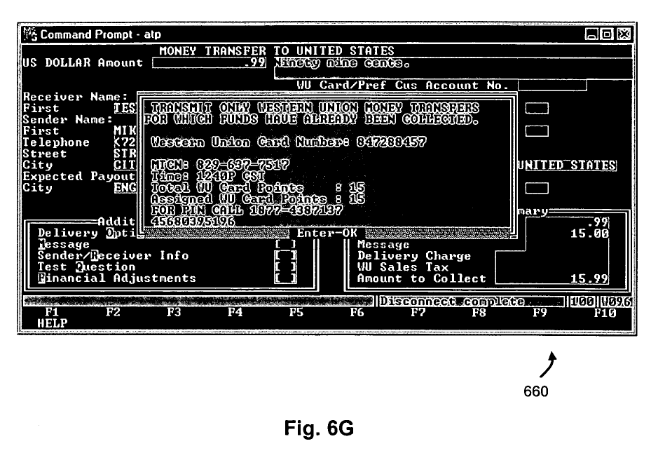

FIG. 5 illustrates a method 500 for awarding a convenience card in accordance with some embodiments of the invention. According to method 500, the customer can initiate a transaction by contacting the transaction provider (block 504). Such contact can occur, inter alia, by telephone (using either a live operator or a VRU), over the Internet, and/or at the physical location of a representative for the transaction provider. For instance, FIG. 6A illustrates an example display screen 600 that can be used by a representative to conduct the card award procedures. The customer then provides the information for the transaction at block 508. This can comprise filling out a form with the relevant information, entering the information into an online form, entering the information with dual tone multi-frequency (“DTMF”) tones, etc. After the information has been provided, the transaction is initiated (block 512). Initiation can consist of a representative performing the transaction with a POS device, an automated script processing an online form, etc. Often, initiation of the transaction will involve the payment of monies by the customer, and such payment can be with cash, credit card, wire transfer, and the like.

In some cases, the transaction can be an independent transaction (such as a money transfer, bill payment, etc.), and the award of a convenience card can be, in a certain respect, ancillary to the transaction itself. In other cases, the transaction itself can involve the convenience card. Merely by way of example, the transaction can comprise a request for enrollment in the convenience card program and/or a request for credit with a particular service provider, such that there is no independent transaction accompanying the award of the convenience card.

In an exemplary embodiment illustrated by FIGS. 6A-6G, a money transfer transaction can be conducted in accordance with certain embodiments of methods similar to method 500, and a convenience card can be awarded at the end of the transaction. Hence, the example display screen 600 includes an option (labeled F5) for performing an independent transaction (e.g., a money transfer), for which a card can be awarded, as well as an option (labeled F8) for an enrollment only.

As illustrated by example screen display 610 of FIG. 6B, once the representative chooses the type of transaction, the representative can be given the option of swiping and/or entering the number of a new or existing convenience card to be used for the transaction. If a card is swiped through a POS device, the field containing the card number can be automatically populated by the POS device. The card number can be sent by the POS device to the transaction provider (and, specifically to the transaction provider control 12), and the transaction provider can then prompt the representative, e.g., via data entry screen 620 and 630 of FIGS. 6C and 6D to enter the relevant information for the transaction, beginning in this example with the destination country for the money transfer and continuing thereafter with the relevant information regarding the receiver of the money. FIG. 6E illustrates an example screen display 640 that allows the representative to input the amount of money collected from the customer. In some embodiments, this amount can include an amount to be transferred, plus any taxes and/or fees, as well as an additional amount, if desired, to be credited toward services on the convenience card. If desired, a receipt can be printed for the money transfer transaction, using a screen similar to the screen 650 displayed on FIG. 6F.

During and/or after the initiation (and, optionally, completion) of the transaction, the relevant customer and/or transaction information provided by the customer at block 408 can be associated with a convenience card (block 516). For example, FIG. 6G illustrates an example screen display 660 that can be displayed for the representative at the end of the transaction. As mentioned above, the convenience card can be a pre-manufactured card and/or can be manufactured on demand, before, during and/or after the initiation and/or completion of the transaction. In this exemplary case, the card was manufactured before the initiation of the transaction and swiped at the initiation. Upon completion, the card number can be automatically associated with the customer information entered during the transaction.

Optionally, credit for goods/services (from the transaction provider and/or from one or more third party service providers) can be added to the card (or an account associated with the card) perhaps as a reward to the customer for engaging in the transaction. In accordance with some embodiments, and for ease of discussion herein, the amount of credit can be thought of as a number of “points” a customer can accumulate thorough processing transactions with the transaction provider, purchasing other goods and services, and the like. In accordance with certain embodiments, the amount of credit to be awarded for a given transaction can be determined (block 520) by the transaction provider's system, based on any of a variety of criteria. It should be appreciated, however, that “points” can correspond to relatively more tangible awards, such as credit that can be used to purchase goods/services (from the transaction provider and/or from third parties), as well as, in some embodiments, a cash or cash-equivalent balance. Thus, in particular embodiments, a convenience card can be associated with one or more debit accounts and can be used as a credit card, ATM card, or the like. In some such embodiments, convenience cards can incorporate the features described in detail in U.S. patent application Ser. No. 09/552,073, filed Apr. 19, 2000 by Coyle et al. and entitled “CASH CARD,” the entire disclosure of which is incorporated herein by reference. Merely by way of example, the transaction provider (and/or a third party) can establish a BIN number for a convenience card, using any suitable method known in the art, allowing the convenience card to be used as a credit card.

Embodiments of the invention allow for relatively extensive flexibility in determining the amount of credit to be awarded to a card (and/or associated account) in connection with a particular transaction. Thus, by using credit awards, the transaction provider can incent customers to engage in transactions deemed relatively desirable by the transaction provider and/or service provider. For instance, when processing a transaction through the transaction provider, a customer sometimes will be assessed a transaction fee, and in some embodiments, varying levels of credit can be awarded based on the amount of the transaction fee. Merely by way of example, processing a transaction with a relatively high associated transaction fee can result in the application of a relatively large credit to the card, while a transaction with a relatively low fee can result in the addition of a relatively low credit. As a simple, illustrative example, a customer may be awarded a number of points corresponding to the amount of the transaction fee, rounded to the nearest dollar, such that a transaction with a $1.00 fee earns one point, while a transaction with a $2.00 fee earns two points. Those skilled in the art will recognize, of course, based on the disclosure herein, that much more complex algorithms linking the transaction fee to the points earned can be implemented in accordance with embodiments of the invention.

As well, embodiments of the invention allow for varying credit awards depending on the type of transaction processed, even if those transactions carry an identical transaction fee. For instance, in some cases, a money transfer transaction will have an associated fee that varies according to the amount of money transferred, regardless of the destination, and the system can be configured to award sufficient credit to allow a telephone call of a given length to the destination country. In such cases, the amount of credit awarded can vary according to the toll charges for a call to the destination country, even if the amount transferred is the same. Thus, more credit might be awarded, for instance, for a money transfer from the United States to Morocco than for a money transfer from the United States to Canada, if toll charges for a call to Canada are, at the time of the transaction, lower than the toll charges for a call to Morocco.

In other embodiments, the level of credit awarded can depend on the type of transaction processed, irrespective of (and/or in further dependence on) the transaction fee associated with the transaction. Merely by way of example, if a transaction provider wants to induce customers to engage in particular types of transactions (new, underutilized, etc.) a relatively high credit can be awarded for processing those types of transactions. In this way, perhaps, a transaction provider can offer “special” deals, either for a limited time or relatively permanently. Similarly, the amount of the credit award can be contingent on the timing of the transaction. For instance, the credit award can be greater if the customer processes the transaction during certain periods of low system utilization (e.g., certain times of day or days of the week, month, year, etc.).

In some cases, the transaction provider's system can be configured automatically and/or dynamically to adjust credit awards in order to accomplish these goals. For instance, if, for whatever reason, the system ascertains that a certain time of day has been underutilized for transactions in the recent past, the system can (with or without operator intervention and/or confirmation) increase the award associated with transaction processed at that time. Conversely, embodiments of the invention allow for awards to be decreased in like fashion. Similarly, returning to the money transfer example above, the credit award for a particular type of money transfer transaction can be adjusted dynamically to account for changing toll rates to the destination country.

Embodiments of the invention can, if desired, provide for notification to the customer of variable awards. For instance, during the processing of a transaction, the system can display to the representative a menu of awards associated with a particular transaction, depending on the timing of the transaction, as well as other variables. Thus, for example, the representative can advise the customer that the transaction would earn more (or less) credit if processed at a different time. In this way, the customer can be encouraged to process future transactions at relatively desirable times. Optionally, the customer can be allowed to schedule the present transaction to be processed at a different time to take advantage of enhanced credit awards. Likewise, the customer can be notified of other enhanced credit awards. Merely by way of example, if a customer processes a money transfer transaction for a given amount, the system can advise the teller (and/or customer) that, if the transaction amount is increased incrementally, the customer will reach an threshold for an enhanced award; alternatively, the system can advise the teller and/or customer of other available credit awards, including for example packaged specials, whereby multiple transactions can, if processed together, result in an additional reward.

After the amount the credit award has been determined, the credit can be added to the card and/or to an account associated with the card (block 524). In the illustrated example, screen display 660 indicates that 15 “points” have been credited to the card as a result of the transaction (as mentioned above, the points can correspond to a more tangible credit denomination, such as minutes, dollars, etc.). As a security measure, the representative can be given a telephone number to call to acquire/activate the PIN associated with the card. At block 528, the card can be presented to the customer. In accordance with various embodiments, the card can be presented to the customer in person, through the mail, etc., as appropriate. If desired, the card can be embossed with the customer's name and/or other identifying information, as well as other information described above.

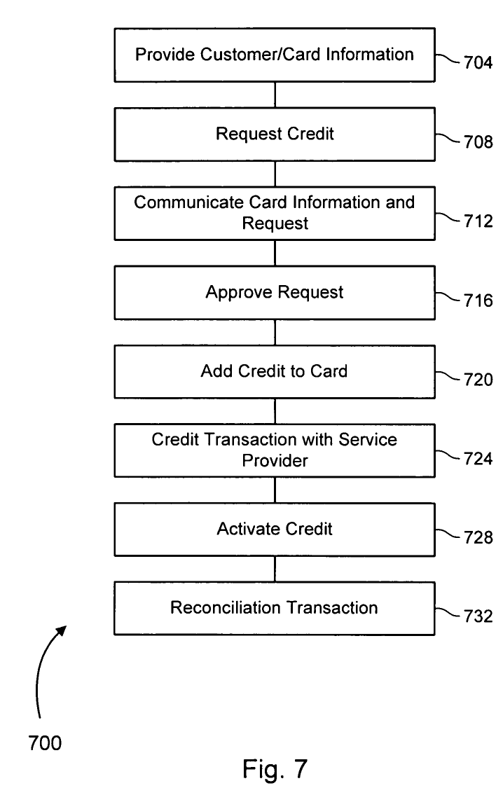

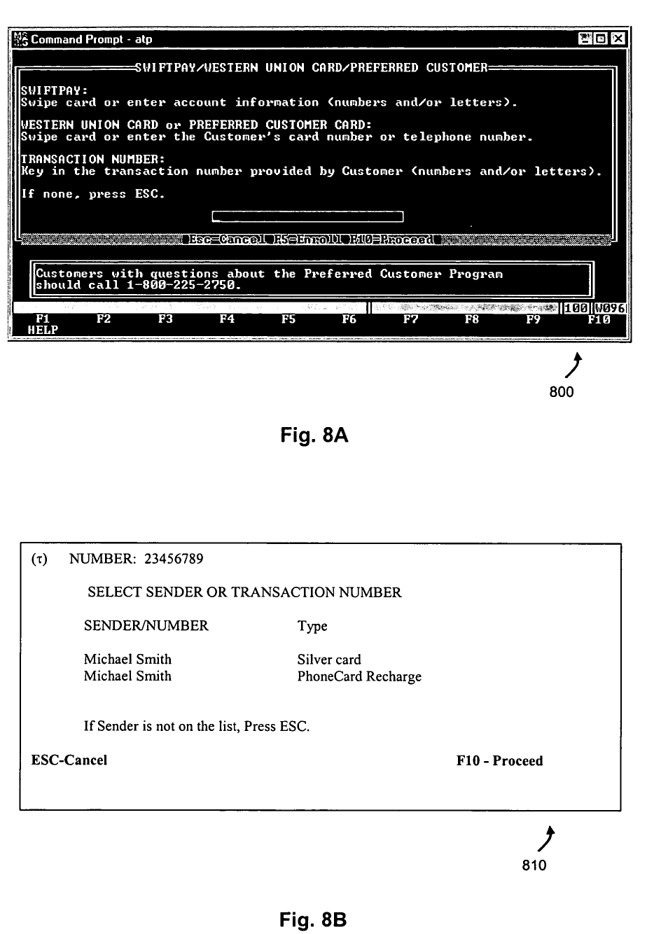

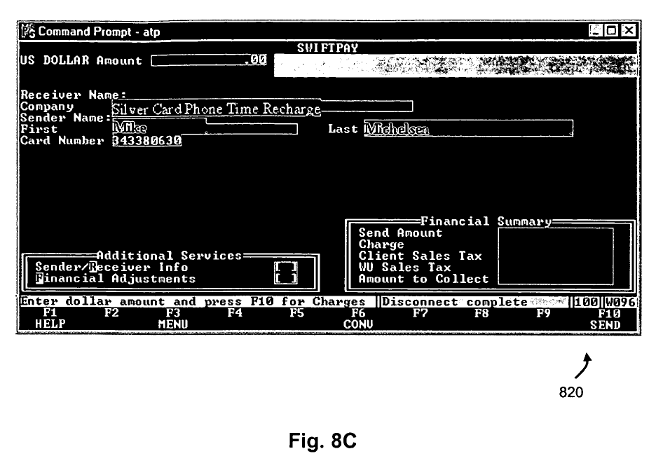

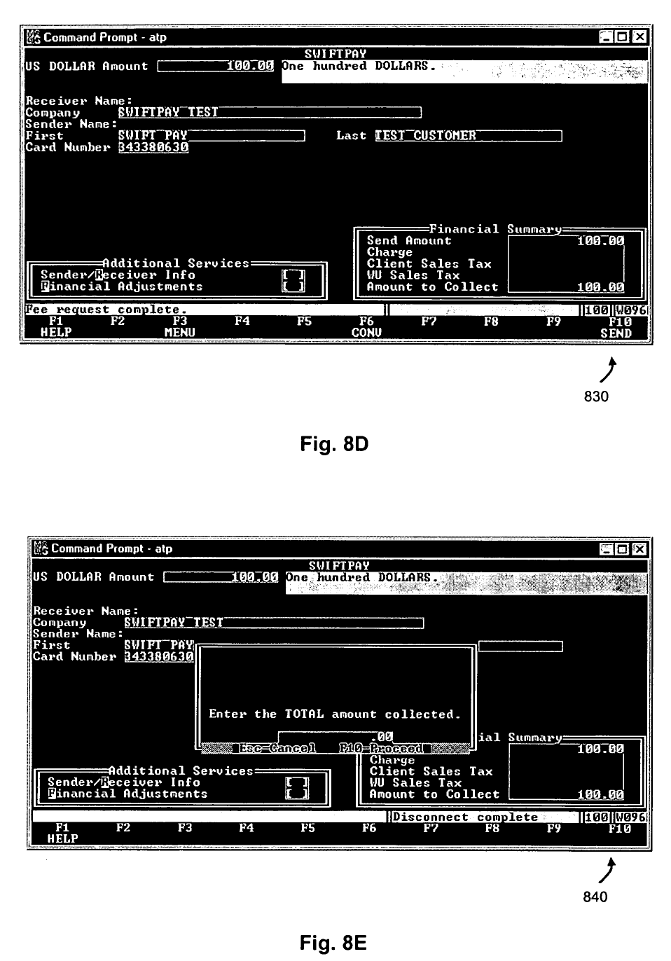

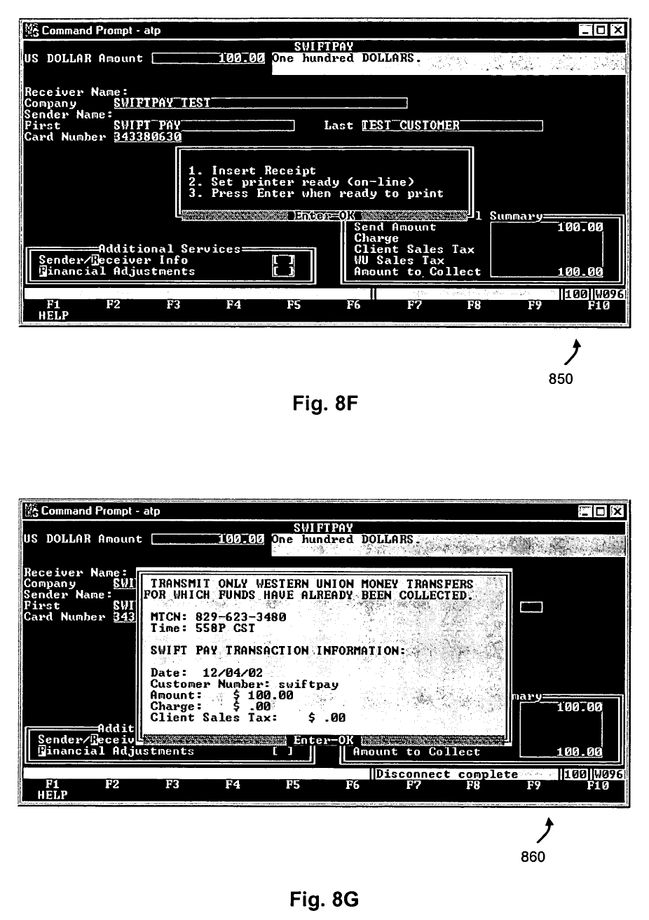

Turning now to FIG. 7, a method 700 is illustrated for adding credit to a convenience card. Methods similar to that illustrated by FIG. 7 can be used to recharge an existing card and/or to add initial credit to a new convenience card. In some cases, the procedures described with respect to FIG. 7 can be performed in person. For instance, at the location of a representative for the transaction provider. In other cases, the procedures can be performed remotely: by telephone (with a live operator and/or a voice response unit “VRU” system known to those skilled in the art), over the Internet, etc. An exemplary embodiment utilizing method 700 can be discussed with reference to FIGS. 8A-8G.

At block 704, the customer provides customer and/or convenience card information. The provision of this information can be accomplished in several fashions. In some cases, for example, when the customer is at a representative location, the convenience card can be swiped through a POS device, and the POS device can obtain sufficient information from the magnetic stripe on the card to allow identification of the card and/or customer. FIG. 8A illustrates an example screen display 800 that can allow a representative to enter a card number manually and/or swipe the card for automatic entry of the number. This swipe procedure can, therefore, allow quick and efficient entry of the necessary information without the need for timely manual data entry. In other cases, the information can be provided orally by the customer to a representative (either in person, over the phone, etc.) or to a VRU capable of interpreting human speech. In still other cases, the information can be provided digitally by the customer, for instance, via an Internet connection and/or a kiosk at a representative location.

In accordance with various embodiments, different types and amounts of information will suffice to identify the card to which credit should be added. In a particular aspect, a customer can provide a telephone number (e.g., in person at a representative location, through the entry of DTMF tones and/or through electronic acquisition of the automatic number identification (“ANI”) of the telephone from which the customer is calling. In other embodiments, the customer can provide a name, address, social security number, etc. sufficient to identify that customer in the transaction provider system. In still other embodiments, the customer can provide the convenience card number, by tendering the convenience card for swiping through a POS device, reading the digits to a representative, etc. The method of providing information and the amount of information provided is discretionary, so long as the information is sufficient to allow identification of the card number/account number to which credit should be added. In some cases, the identifying information provided by the customer may not be sufficient to allow for unique identification of that customer. Merely by way of example, a customer might provide his ten-digit telephone number as identifying information, and that ten-digit number might also correspond to a transaction identifier and/or customer identifier for another customer. In such cases, the system can be configured to display a menu of all customers and/or transactions associated with the provided identifying information, and the customer and/or representative can select the appropriate entry from the menu and/or add a new entry (for instance, if none of the listed entries are associated with the customer).

After the card number/account number has been identified, a request for credit can be entered (block 708), using any appropriate communication device, including, as discussed above, POS device, web browser, telephone, etc. In some cases, the request for credit can be automatic (for instance, if the credit is awarded to the customer in connection with the purchase of a good or services, including for example, a money transfer transaction), requiring no input from the representative and/or the customer. In other cases, the request for credit can be initiated manually (including, for instance, cases where the customer requests a credit independent of any award). Thus, in some cases, a menu of available credit options can be offered to the customer and/or to a representative of the transaction provider, and the request for credit can comprise selecting from the menu. Merely by way of example, after the card number has been identified, the POS device can display a menu of available providers, service offerings and/or credit amounts, and a selection can be chosen from the menu.

FIG. 8B illustrates a screen display 810 that can be used to select a service for which to request credit. In this case, the customer can choose to make a transaction with the convenience card and/or “recharge” (i.e., add credit or cash) to an account associated with the card. For example, the customer might choose to add minutes to a prepaid telephone service associated with the card. Alternatively, a search can be performed for a particular service provider and/or service offering for which credit is desired. Along with the service provider and/or service, the amount of credit to be added can specified. In some cases, the amount of credit can be chosen from among predefined values (e.g., credit can be added in discrete blocks of money, phone time, etc.), while in other embodiments the customer can be given the choice of any amount of credit in any of a variety of denominations to be added to the card. Merely by way of example, in some embodiments, a customer could choose to add 47 minutes of phone time and/or could choose to add $2.37 to a particular account, while in others the customer could specify an amount in $5.00 increments. For example, as illustrated on display screen 820 of FIG. 8C, the representative can type in any amount of credit to add with respect to the requested service. In some cases, the request to add credit can be structured similar to a money transfer, wherein the receiver for the request is the account associated with the card number. Hence, the request to add credit can be accommodated by an existing system that is able to perform money transfer operations. In a particular aspect, the display screen 820 can display the card number to the representative to ensure against mistake.

In some embodiments, the provision of customer information and request for credit can be consolidated. For instance, a customer might fill out a form (paper or electronic) at a representative location, specifying a card number (and/or other identifying information, such as a telephone number), an amount of requested credit, and the service for which credit is requested. (Alternatively, a particular convenience card may be associated with only one particular service provider and/or only one service offering, obviating the need to specify this information.) The customer then could submit the form, and a representative could process the transaction using the data on the form. In accordance with some embodiments, the request for credit might be accompanied by a payment from the customer. For example, FIG. 8D illustrates an example display screen 830 that prompts the representative to collect the proper amount (inclusive of taxes and/or fees) to provide the amount of credit requested. In other embodiments, the request for credit might require no payment; for instance the credit could be given to the customer as an award, merely by way of example, for being a loyal customer.

After the card has been identified and a credit request has been entered into the communication device (e.g., POS device), the card information and credit request can be communicated to the transaction provider, for instance, as a message from a POS device to payment provider control 130 (block 712). In some embodiments, the data entry and communication procedures can utilize the methods discussed in detail in the following copending applications, the entire disclosures of which are incorporated herein by reference for all purposes: U.S. patent application Ser. No. 09/823,697, entitled “PAYMENT SERVICE METHOD AND SYSTEM,” and filed Mar. 31, 2001; U.S. patent application Ser. No. 09/990,702, entitled ELECTRONIC IDENTIFIER PAYMENT SYSTEM AND METHODS,” and filed Nov. 9, 2001; U.S. patent application Ser. No. 10/007,701, entitled ELECTRONIC IDENTIFIER PAYMENT SYSTEM AND METHODS,” and filed Dec. 10, 2001; and U.S. patent application Ser. No. 10/112,258 entitled ELECTRONIC IDENTIFIER PAYMENT SYSTEMS AND METHODS,” and filed Mar. 29, 2002, already incorporated herein by reference. Optionally, the request can be approved by the transaction provider (block 716). Approval can comprise, among other things, seeking verification of the funds provided to purchase the credit, etc. Verification could include requiring the representative to affirm that he or she received certified funds from the customer, validating a credit card number, etc. For instance, FIG. 8E illustrates an example screen display 840 requiring the representative to affirm the amount collected from the customer.

At block 720, credit can be added to the card by the transaction provider. In many cases, this procedure comprises forming a message to be sent to the service provider to add credit to the PIN number associated with the card for which credit has been requested. In other cases, adding credit to the card can include updating a record in the transaction provider's database to indicate that a certain amount of credit has been added to the card, such as when the transaction provider wishes to track the credit on the card independently of the service provider's records. In some cases, a confirmation, in the form of a receipt and/or confirmation number, can be provided. Merely by way of example, FIGS. 8F and 8G illustrate example display screens 850, 860 that allow the printing of a receipt and display a confirmation number, respectively. Alternatively, the system can wait to provide such confirmation until receiving a reconciliation transaction from the service provider, as discussed below.

At block 724, a credit transaction occurs between the transaction provider and the service provider. In accordance with some embodiments, the credit transaction comprises a message that is sent to the service provider (using any of the communication procedures discussed above), indicating the PIN number and/or the convenience card number to which credit should be applied, along with the amount of credit to be applied to the account. Alternatively, the service provider can be configured so that, for a given PIN number, only a fixed amount of credit can be added in any given transaction. In such cases, the message might not include an amount to be credited, and the message may in fact be a plurality of messages relating to the same PIN number, such that the aggregate amount of credit from each of the messages comprises the credit requested by (or awarded to) the customer. In some embodiments, individual credit transactions can be processed each time credit is to be added to an account. In other embodiments, credit transactions can processed in a batch mode (perhaps at a specified interval, e.g., every minute, hour, etc., and/or after a certain number of transactions have accumulated at the transaction provider).

In some cases, the transaction provider will specify the amount of credit to be added to a particular account, in any appropriate denomination (points, minutes, dollars, etc.). In other cases, the service provider may determine the amount of the credit, perhaps based on input from the transaction provider. For instance, if a customer receives, as an award for transferring money to a certain destination, the value of a telephone call of a specified duration to that destination, the transaction provider could initiate a credit transaction specifying that the credit should be sufficient to allow the customer to place a telephone call of the specified duration to the destination, and the service provider can, based perhaps on prevailing rates, determine the amount of credit necessary to allow such a call. In another example, if a customer is rewarded for purchasing four compact discs with credit for another compact disc, the credit transaction could specify that the account should be awarded with sufficient credit to allow the customer to obtain a free compact disc at prevailing prices. That credit, then, either can be converted into a more abstract value (dollars, points, etc.) or stored in a more specific denomination (such as, in this example, a credit for one compact disc).

At block 728, the credit can be activated by the service provider. In some cases, activation comprises enabling the PIN to be used to acquire goods and/or use services (e.g., where there is not an existing credit balance associated with the PIN), while in other cases, activation comprises adding additional credit to an existing credit balance. In certain aspects, the transaction (block 724) and activation (block 728) procedures occur with little or no delay after the communication of a request to the transaction provider and/or approval of a request, such that activation can appear to the customer to be instantaneous.

In some embodiments, there may be one or more reconciliation transactions (block 732), whereby the service provider confirms to the transaction provider that the credit has been applied to the PIN number as requested and/or whereby the transaction provider pays the service provider for the credit added to the customer's account. As mentioned above, such reconciliation transactions may utilize an ACH transaction. In other cases, reconciliation transactions may comprise a batch billing and/or payment. In still other cases, certain reconciliation transactions can occur relatively quickly after activation, such that the representative and/or user can be notified that the credit was added successfully to the customer's card.

In accordance with certain embodiments, one or more of the procedures discussed with regard FIG. 7 can be omitted and/or can take place automatically. For instance, when, as discussed above, a customer is issued a credit as a reward (e.g., for placing a money-transfer transaction with the transaction provider), method 700 could be used to issue that credit, but blocks 704-716 could be omitted, since that information might be unnecessary: the transaction provider likely already would know the card number and the amount of credit to be added to the card and (assuming the card contained credit for only one service provider), the service for which credit is to be issued, and authorization would be unnecessary, since the credit is issued as a reward.

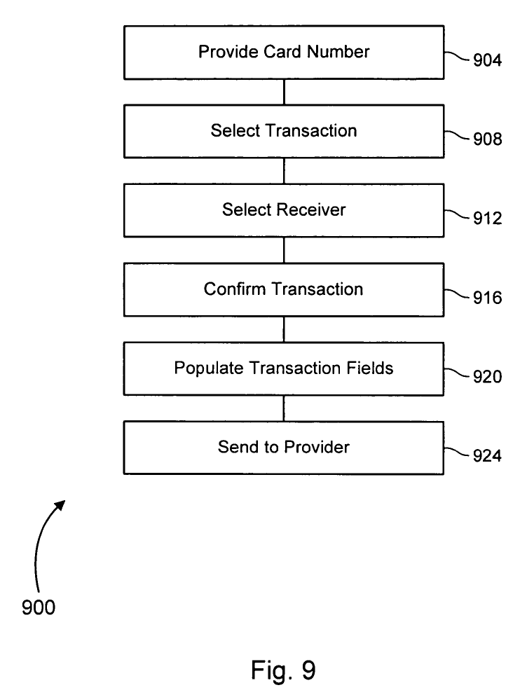

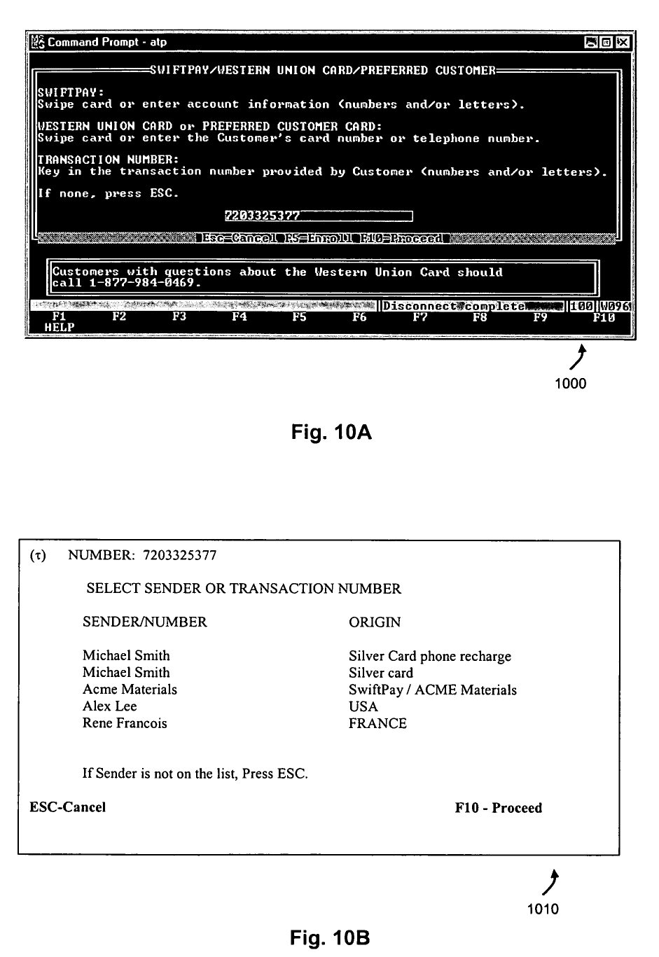

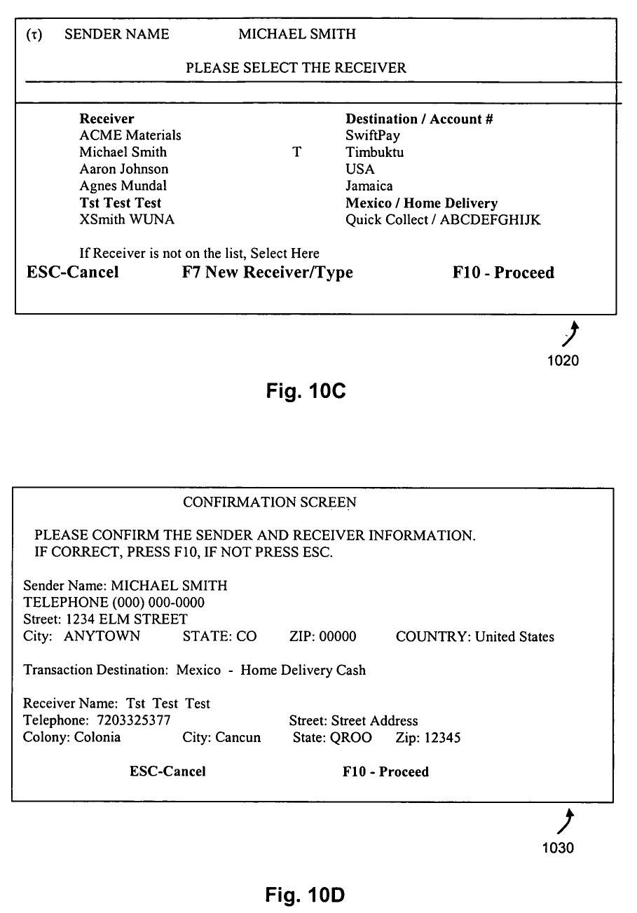

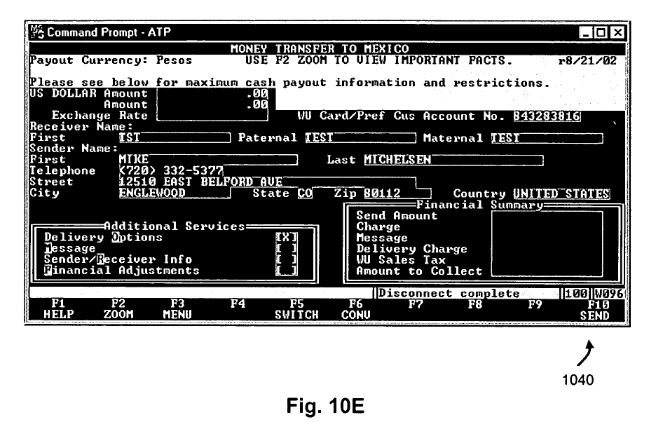

As mentioned above, convenience cards in accordance with certain embodiments of the invention can provide for more expeditious data entry, thereby allowing transactions that are more convenient for the customer, the representative and the transaction provider. For example, FIG. 9 illustrates a method 900 for automatically preparing a transaction form in accordance with embodiments of the invention, and FIGS. 10A-10E illustrate example screen displays that can be used to perform method 900.

At block 904, the convenience card number is provided. As mentioned above and illustrated on example screen display 1000 on FIG. 10A, this can be performed by swiping the card or providing other information sufficient to identify the card number and/or customer, such as, for example, a telephone number. After the card number is provided, a menu of senders and/or preferred transactions is provided (block 908), as illustrated on example screen display 1010 of FIG. 10B. Each entry on the menu can link to stored transaction information at the transaction provider, such that all information (or any subset thereof) about a particular sender and/or transaction necessary to complete a transaction can quickly be downloaded from the transaction provider and/or service provider and thus can be used to eliminate time-consuming and error-prone data entry by the representative and/or customer. Preferred transactions can include transactions conducted by the customer in the past, transactions popular with other customers, and the like. In a certain embodiment, the menu can include all available transactions. In other embodiments, the menu can include transactions involving senders affiliated with the customer and/or the card number. If the desired sender and/or transaction is not listed, a new sender or transaction can be created (and, optionally, will be included in the menu the next time the system is used by that customer). Transactions can include bill payment transactions, money transfer transactions, and the like, including the transactions referenced in copending U.S. Patent Application. Nos. 09/823,679, 09/990,702, and 10/007,701, already incorporated by reference.

At block 912, a recipient can be chosen from a menu, perhaps using a screen similar to the example screen 1020 depicted on FIG. 1C. Again, the menu can include past recipients for a particular sender and/or type of transaction and/or common recipients (e.g., popular utility companies, mortgage companies, and the like), and new recipients can be defined (and, optionally, included in the menu upon the next use of the system by the customer). Optionally, the customer and/or representative then can confirm the chosen transaction (block 916), as illustrated by example screen display 1030 of FIG. 10D. As much or as little information as desired can be shown on screen display 1030, so long as the customer is able to confirm that the sender, recipient and type of transaction are correct.

At block 920, a transaction form (either online or paper) can be populated with the appropriate stored information for the chosen transaction, sender and recipient, as illustrated on display screen 1040 of FIG. 10E. Information that was not stored for the transaction, sender and/or recipient can be provided, and any information can be changed as desired. Then, the transaction can be sent to the transaction provider for execution (block 924). Optionally, any new or changed information about the customer can be saved automatically by the transaction provider's system, updating the appropriate customer record. If desired, the customer can be given the option to specify whether the information should apply only to the current transaction or be used to update the customer record.

For ease of description, the procedures discussed herein have been organized into separate exemplary methods. It should be noted, however, that in accordance with certain embodiments of the invention, the methods described above can be combined as appropriate and/or necessary, and certain steps may be omitted and/or reordered. Thus, for example, a transaction processed according to the method 500 described in relation to FIG. 5 resulting in a credit award can implement certain procedures described as part of method 700 described in relation to FIG. 7; likewise the exemplary card issuance and data entry procedures described in relation to FIGS. 4 and 9, respectively, can be implemented in conjunction with these methods as well.

In addition, the flexibility of the systems and methods described herein can allow for the incorporation of additional features, including without limitation those described in U.S. patent application Ser. Nos. 09/552,073, 09/634,901, 09/823,697, 09/990,702, 10/007,701, and 10/112,258, all previously incorporated by reference. Merely by way of example, in accordance with certain embodiments, a customer can be provided with the opportunity to recharge certain prepaid services, whether or not associated with the transaction provider and/or service provider. For instance, upon swiping a convenience card, the customer can be prompted for his cellular telephone number. Once the phone number has been entered, the phone number can be correlated to the customer's account at the transaction provider. (Alternatively, if the phone number already has been correlated with the account, swiping the convenience card can produce a display screen with the cellular number already filled in). If necessary, the phone number then can be indexed in a database (which can be in communication with and/or incorporated within, inter alia, the transaction provider control or the service provider control) to determine whether the cellular number corresponds to a prepaid cellular account with a cellular provider (which may or may not be the service provider), and/or to identify the cellular provider associated with that number.

Optionally, this information can be associated with the customer's account at the transaction provider as well, to avoid the need to perform such database indexing in the future. The customer then can be offered the opportunity to purchase additional cellular minutes for that account, using credit and/or stored value from the convenience card account and/or another source of funds, and if the customer chooses to purchase such minutes, the transaction provider can initiate a transaction with the cellular provider to fulfill that purchase, perhaps using methods described above. Optionally, the customer can be given an award, in the manner discussed above, for the purchase of cellular minutes. Based on the disclosure herein, those skilled in the art will appreciate that the flexibility of various embodiments of the invention allow for the implementation of additional, similar features.

In this way, embodiments of the invention provide money transfer convenience cards and methods and systems for their use. The description above identifies certain exemplary embodiments for implementing the invention, but those skilled in the art will recognize that many modifications and variations are possible within the scope of the invention. The invention, therefore, is defined only by the claims set forth below.

What is claimed is:

1. In a relationship between a customer, a transaction provider and a service provider, the transaction provider providing money transfer services for the customer and the customer having an account associated with a convenience card, a system for enhancing customer loyalty in money transfer transactions, the system comprising:
a communication network, the communication network being configured to transport information relating to the money transfer services provided by the transaction provider;
a point of sale device in communication with the communication network, the point of sale device being located at a particular origination location and configured to receive an identifier, the identifier including sufficient identifying information to allow the transaction provider to identify the customer's account, to receive a request from the customer to process a money transfer transaction to a particular destination location, and to transmit the identifier and the request to process a money transfer transaction; and
a transaction provider control in communication with the communication network and further in communication with a service provider, the transaction provider control being configured to receive the identifier and the request to process a money transfer transaction from the point of sale device, to identify the customer's account based on the identifying information included in the identifier, and to credit the customer's account with an award associated with the request to process a money transfer transaction, the award being redeemable by the customer for credit toward the purchase of a product from the service provider.

2. A system for enhancing customer loyalty in money transfer transactions as recited in claim 1, wherein the point of sale device is further configured to receive the identifier by reading the identifier from the convenience card as the convenience card is swiped though the point of sale device.

3. A system for enhancing customer loyalty in money transfer transactions as recited in claim 1, wherein the identifier is a telephone number.

4. A system for enhancing customer loyalty in money transfer transactions as recited in claim 1, wherein the service provider is a merchant, and wherein the product is a tangible good.

5. A system for enhancing customer loyalty in money transfer transactions as recited in claim 1, wherein the service provider is a telecommunication service provider, and wherein the product is a telecommunication service.

6. A system for enhancing customer loyalty in money transfer transactions as recited in claim 5, wherein the award credited to the customer's account by the transaction provider control comprises sufficient credit to allow the customer to place a telephone call of a certain duration from the particular origination location to the particular destination location.

7. A system for enhancing customer loyalty in money transfer transactions as recited in claim 1, wherein the transaction provider control comprises a database, which includes information about the customer's account.

8. A system for enhancing customer loyalty in money transfer transactions as recited in claim 7, wherein the transaction provider control is further configured to update the second account with information related to the money transfer transaction.

9. A system for enhancing customer loyalty in money transfer transactions as recited in claim 1, wherein the service provider comprises a service provider control in communication with the transaction provider control, the service provider control comprising a database, which includes information about the customer's account.

10. A system for enhancing customer loyalty in money transfer transactions as recited in claim 1, wherein the customer's account is maintained by the transaction provider.

11. A system for enhancing customer loyalty in money transfer transactions as recited in claim 1, wherein the customer's account is maintained by the service provider.

12. A system for enhancing customer loyalty in money transfer transactions as recited in claim 11, wherein crediting the customer's account with an award comprises sending a message to the service provider, the message including sufficient information to indicate the amount of the credit to be awarded to the customer's account.

13. A system for enhancing customer loyalty in money transfer transactions as recited in claim 12, wherein the message specifies the amount of credit to be awarded to the customer's account.

14. A system for enhancing customer loyalty in money transfer transactions as recited in claim 12, wherein the message includes sufficient information about the money transfer transaction to allow the service provider to determine the amount of credit to be awarded to the customer's account.

15. A system for enhancing customer loyalty in money transfer transactions as recited in claim 14, wherein the message comprises information about the particular destination location and the particular origination location.

16. A system for enhancing customer loyalty in money transfer transactions as recited in claim 11, wherein the customer's account is a first account, and wherein the convenience card is further associated with a second account maintained by the transaction provider.

17. A system for enhancing customer loyalty in money transfer transactions as recited in claim 16, wherein the transaction provider control is further configured to update the second account with information related to the money transfer transaction.

18. A system for enhancing customer loyalty in money transfer transactions as recited in claim 1, wherein the particular origination location and the particular destination location are the same location.

19. A system for enhancing customer loyalty in money transfer transactions as recited in claim 1, wherein the award is based on a determinant selected from the group consisting of the amount of the money transfer transaction, the originating location of the money transfer transaction, the destination location of the money transfer transaction, the timing of the money transfer transaction, an amount of a service fee associated with the money transfer transaction, and a type of money transfer transaction requested.

20. A system for enhancing customer loyalty in money transfer transactions, the system comprising:
a transaction provider control in communication with a third-party service provider;
a point of sale device in communication with the transaction provider control, wherein the point of sale device comprises a processor and a storage medium, and wherein the storage medium includes instructions executable by the processor to:
receive an identifier associated with a convenience card, wherein the convenience card is associated with an account at the service provider;
receive a request for a money transfer transaction; and
transmit the money transfer transaction request to the transaction provider control for execution.

21. The system of claim 20, wherein the transaction provider control comprises a second processor and a second storage medium, and wherein the second storage medium includes instructions executable by the second processor to:
receive a money transfer transaction request from the point of sale device;
receive the identifier from the point of sale device;
associate the money transfer transaction with the identifier; and
transmit a request to the third-party service provider to add credit to the service provider account associated with the convenience card, wherein the credit is based at least in part on the money transfer transaction.

22. The system of claim 21, wherein the transaction provider control comprises a third storage medium, the third storage medium comprising a database including a transaction provider account associated with the convenience card, and wherein the second storage medium includes instructions executable by the second processor to update the transaction provider account with information related to the requested money transfer transaction.

23. A money transfer convenience card that can be used to facilitate a money transfer transaction through a transaction provider, wherein the money transfer convenience card is associated with an account, such that when the money transfer convenience card is used to facilitate a money transfer transaction through the transaction provider, an award is credited to the account associated with the convenience card, the award being redeemable toward the purchase of a product from a service provider and being based at least in part on the money transfer transaction.

24. A money transfer convenience card as recited in claim 23, wherein the service provider is a telecommunication service provider, and wherein the certain amount of credit can be used toward the purchase of a telecommunication service.

25. A money transfer convenience card as recited in claim 24, wherein the telecommunication service is telephone service, wherein the money transfer transaction has a certain origination location and a certain destination location, and wherein the award is sufficient to allow a telephone call of a certain duration between the certain origination location and the certain destination location.

26. A money transfer convenience card as recited in claim 23, wherein the award is based on a determinant selected from the group consisting of the amount of the money transfer transaction, the originating location of the money transfer transaction, the destination location of the money transfer transaction, the timing of the money transfer transaction, an amount of a service fee associated with the money transfer transaction, and a type of money transfer transaction requested.

27. A money transfer convenience card as recited in claim 23, wherein the account is maintained by the transaction provider.

28. A money transfer convenience card as recited in claim 23, wherein the account is maintained by the service provider.

29. A money transfer convenience card as recited in claim 28, wherein the customer's account is a first account, and wherein the convenience card is further associated with a second account maintained by the transaction provider.

30. In a relationship between a customer, a transaction provider and a service provider, the transaction provider providing money transfer services for the customer and the customer having an account, the account being associated with a convenience card, a method for enhancing customer loyalty in money transfer transactions, the method comprising:
receiving a request from a customer to process a money transfer transaction, wherein the money transfer transaction has a certain origination location and a certain destination location;
receiving an identifier, the identifier including sufficient identifying information to allow the customer's account to be identified;
identifying the customer's account based on the identifying information included in the identifier; and
crediting an account with an award based at least in part upon the requested money transfer transaction, the award being redeemable by the customer for credit toward the purchase of a product from a service provider.

31. A method for enhancing customer loyalty in money transfer transactions as recited in claim 30, wherein receiving an identifier comprises receiving an identifier from a convenience card associated with the customer's account.

32. A method for enhancing customer loyalty in money transfer transactions as recited in claim 31, wherein receiving an identifier comprises reading an identifier from a convenience card swiped through a point of sale device.

33. A method for enhancing customer loyalty in money transfer transactions as recited in claim 30, wherein the identifier is a telephone number.

34. A method for enhancing customer loyalty in money transfer transactions as recited in claim 30, wherein the account is maintained by the transaction provider.

35. A method for enhancing customer loyalty in money transfer transactions as recited in claim 30, wherein the account is maintained by the service provider.

36. A method for enhancing customer loyalty in money transfer transactions as recited in claim 30, wherein crediting the customer's account with an award comprises sending a message to the service provider, the message including sufficient information to indicate the amount of the credit to be awarded to the customer's account.

37. A method for enhancing customer loyalty in money transfer transactions as recited in claim 36, wherein the message specifies the amount of credit to be awarded to the customer's account.

38. A method for enhancing customer loyalty in money transfer transactions as recited in claim 36, wherein the message includes sufficient information about the money transfer transaction to allow the service provider to determine the amount of credit to be awarded to the customer's account.

39. A method for enhancing customer loyalty in money transfer transactions as recited in claim 38, wherein the message comprises information about the particular destination location and the particular origination location.

40. A method for enhancing customer loyalty in money transfer transactions as recited in claim 35, wherein the account is a first account, and wherein the convenience card is further associated with a second account maintained by the transaction provider.

41. A method for enhancing customer loyalty in money transfer transactions as recited in claim 30, wherein the service provider is a merchant, and wherein the product is a tangible good.

42. A method for enhancing customer loyalty in money transfer transactions as recited in claim 30, wherein the service provider is a telecommunication service provider and wherein the product is a telecommunication service.

43. A method for enhancing customer loyalty in money transfer transactions as recited in claim 42, wherein the award credited to the customer's account by the transaction provider control comprises sufficient credit to allow the customer to place a telephone call of a certain duration from the particular origination location to the particular destination location.

44. A method for enhancing customer loyalty in money transfer transactions as recited in claim 30, wherein the particular origination location and the particular destination location are the same location.

45. A method for enhancing customer loyalty in money transfer transactions as recited in claim 30, wherein the award is based on a determinant selected from the group consisting of the amount of the money transfer transaction, the originating location of the money transfer transaction, the destination location of the money transfer transaction, the timing of the money transfer transaction, an amount of a service fee associated with the money transfer transaction, and a type of money transfer transaction requested.

46. A method for enhancing customer loyalty in money transfer transactions as recited in claim 30, further comprising updating the account with information related to the money transfer transaction.

47. A method for enhancing customer loyalty in money transfer transactions, the method comprising:
receiving an identifier associated with a money-transfer convenience card, wherein the money-transfer convenience card is associated with an account at a third-party service provider;
processing a money transfer transaction;
associating the money transfer transaction with the identifier; and
adding credit to the account at the third-party service provider, wherein the credit is based at least in part on the money transfer transaction.

48. In a relationship between a customer, a transaction provider and a service provider, the transaction provider providing money transfer services for the customer and the customer having an account, the account being associated with a convenience card, a method for enhancing customer loyalty in money transfer transactions, the method comprising:
receiving at a point of sale device an identifier from a convenience card, the identifier including sufficient identifying information to allow the transaction provider to identify the customer's account, the point of sale device being situated at a particular origination location;
receiving at the point of sale device a request from the customer to process a money transfer transaction to a particular destination location;
transmitting via a communication network the identifier and the request to process a money transfer transaction;
receiving at a transaction provider control the identifier and the request to process a money transfer transaction;
identifying the customer's account based on the identifying information included in the identifier;
calculating an amount of prepaid telephone service credit sufficient to allow the customer to place a telephone call of a certain duration from the origination location to the destination location, such that the customer can call a receiving party near the destination location to inform the receiving party that the customer has placed a request to process a money transfer transaction to the destination location; and
crediting the customer's account with an award, the award being equivalent to the calculated amount of prepaid telephone service credit and based at least in part on the request to process a money transfer transaction.

49. In a relationship between a customer, a transaction provider and a service provider, the transaction provider providing money transfer services for the customer and the customer having an account, the account being associated with a convenience card, a system for enhancing customer loyalty in money transfer transactions, the system comprising:
a communication network, the communication network being configured to transport information relating to the money transfer services being provided by the transaction provider;
means for receiving an identifier from the convenience card, the identifier including sufficient identifying information to allow the transaction provider to identify the customer's account with the transaction provider, the means for receiving an identifier from the convenience card being situated at a particular origination location;
means for receiving a request from the customer to process a money transfer transaction to a particular destination location;
means for transmitting via the communication network the identifier and the request to process a money transfer transaction;
means for receiving via the communication network the identifier and the request to process a money transfer transaction;
means for identifying the customer's account based on the identifying information included in the identifier;
means for calculating an amount of prepaid telephone service credit sufficient to allow the customer to place a telephone call of a certain duration from the origination location to the destination location, such that the customer can call a receiving party near the destination location to inform the receiving party that the customer has placed a request to process a money transfer transaction to the destination location; and
means for crediting the customer's account with an award, the award being equivalent to the calculated amount of prepaid telephone service credit and based at least in part on the request to process a money transfer transaction.

50. In a relationship between a customer, a transaction provider and a service provider, the transaction provider providing money transfer services for the customer and the customer having an account, the account being associated with a convenience card, a system for enhancing customer loyalty in money transfer transactions, the system comprising:
a communication interface;
a processor in communication with the communication interface; and
a computer readable medium in communication with the processor, the computer readable medium comprising instructions executable by the processor to:
receive an identifier associated with an account;
receive a request to process a money transfer transaction;
process the money transfer transaction; and
credit the account with an award based at least in part upon the requested money transfer transaction, the award being redeemable by the customer for credit toward the purchase of a product from a service provider.

51. In a relationship between a customer, a transaction provider and a service provider, the transaction provider providing money transfer services for the customer and the customer having an account, the account being associated with a convenience card, a system for enhancing customer loyalty in money transfer transactions, the system comprising:
a communication interface;
a processor in communication with the communication interface; and
a computer readable medium in communication with the processor, the computer readable medium comprising instructions executable by the processor to:
receive from a point of sale device an identifier associated with a convenience card, the identifier including sufficient identifying information to allow the transaction provider to identify the customer's account;
receive from a point of sale device a request from the customer to process a money transfer transaction from a particular origination location to a particular destination location;
identify the customer's account based on the identifying information included in the identifier;
calculate an amount of prepaid telephone service credit sufficient to allow the customer to place a telephone call of a certain duration from the origination location to the destination location, such that the customer can call a receiving party near the destination location to inform the receiving party that the customer has placed a request to process a money transfer transaction to the destination location; and
credit the customer's account with an award, the award being equivalent to the calculated amount of prepaid telephone service credit and based at least in part on the request to process a money transfer transaction.
